(19) United States
(12) Patent Application Publication
(10) Pub. No.: US 2025/0301511 A1
(43) Pub. Date: Sep. 25, 2025

(54) NETWORK INTERFACE UNAVAILABILITY CONFIGURATION

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Geetha Priya RAJENDRAN, Bangalore (IN); Prasada Veera Reddy KADIRI, San Diego, CA (US)

(21) Appl. No.: 18/609,439

(22) Filed: Mar. 19, 2024

(51) Int. Cl. H04W 76/10; H04W 80/10

(52) U.S. Cl. CPC H04W 76/10; H04W 80/10

(57) ABSTRACT

Various aspects of the present disclosure generally relate to wireless communication. In some aspects, a first network node may receive information that indicates an expected unavailability of a second network node or a network interface between the first network node and the second network node. The first network node may determine, in accordance with the received information, that a state of the second network node or the network interface between the first network node and the second network node is an unavailable state. The first network node may maintain an application layer configuration associated with the second network node or the network interface while the state of the second network node or the network interface is the unavailable state. Numerous other aspects are described.

### FIELD OF THE DISCLOSURE

Aspects of the present disclosure generally relate to wireless communication and specifically relate to techniques, apparatuses, and methods associated with a network interface unavailability configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a first network node. The method may include receiving information that indicates an expected unavailability of a second network node or a network interface between the first network node and the second network node. The method may include determining, in accordance with the received information, that a state of the second network node or the network interface between the first network node and the second network node is an unavailable state. The method may include maintaining an application layer configuration associated with the second network node or the network interface while the state of the second network node or the network interface is the unavailable state.

Some aspects described herein relate to an apparatus for wireless communication. The apparatus may include one or more memories and one or more processors coupled to the one or more memories. The one or more processors may be configured to receive information that indicates an expected unavailability of a network node or a network interface between the apparatus and the network node. The one or more processors may be configured to determine, in accordance with the received information, that a state of the network node or the network interface between the apparatus and the network node is an unavailable state. The one or more processors may be configured to maintain an application layer configuration associated with the network node or the network interface while the state of the network node or the network interface is the unavailable state.

Some aspects described herein relate to an apparatus for wireless communication. The apparatus may include means for receiving information that indicates an expected unavailability of a network node or a network interface between the apparatus and the network node. The apparatus may include means for determining, in accordance with the received information, that a state of the network node or the network interface between the apparatus and the network node is an unavailable state. The apparatus may include means for maintaining an application layer configuration associated with the network node or the network interface while the state of the network node or the network interface is the unavailable state.

Some aspects described herein relate to a non-transitory computer-readable medium that stores a set of instructions for wireless communication by a first network node. The set of instructions, when executed by one or more processors of the first network node, may cause the first network node to receive information that indicates an expected unavailability of a second network node or a network interface between the first network node and the second network node. The set of instructions, when executed by one or more processors of the first network node, may cause the first network node to determine, in accordance with the received information, that a state of the second network node or the network interface between the first network node and the second network node is an unavailable state. The set of instructions, when executed by one or more processors of the first network node, may cause the first network node to maintain an application layer configuration associated with the second network node or the network interface while the state of the second network node or the network interface is the unavailable state.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of non-terrestrial network (NTN) architectures, in accordance with the present disclosure.

FIG. 5 is a diagram illustrating an example of a backhaul network interface configuration, in accordance with the present disclosure.

FIGS. 6A-6C are diagrams illustrating examples associated with configuring a core network (CN) node with information that indicates an expected availability status for a radio access network (RAN) node, in accordance with the present disclosure.

FIGS. 7A-7C are diagrams illustrating examples associated with configuring a RAN node with information that indicates an expected availability status for a CN node, in accordance with the present disclosure.

FIG. 8 is a diagram illustrating an example associated with configuring a CN node with information to identify a RAN node associated with an availability status that changes over time, in accordance with the present disclosure.

FIGS. 9A-9D are diagrams illustrating examples associated with a CN node identifying a RAN node associated with an availability status that changes over time in accordance with one or more identities associated with the RAN node, in accordance with the present disclosure.

FIG. 10 is a diagram illustrating an example associated with configuring a RAN node with information to identify a CN node associated with an availability status that changes over time, in accordance with the present disclosure.

FIGS. 11A-11D are diagrams illustrating examples associated with a RAN network node identifying a CN node associated with an availability status that changes over time in accordance with one or more identities associated with the CN node, in accordance with the present disclosure.

FIG. 12 is a diagram illustrating an example associated with recovering from an error state in which a peer network node does not retain an application layer configuration for a network interface after one or more changes to an availability status of the peer network node, in accordance with the present disclosure.

FIG. 13 is a flowchart illustrating an example process performed, for example, by a first network node, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

As described herein, a first network node and a second network node may generally communicate over a network interface. For example, in some cases, a radio access network (RAN) node, such as a distributed unit (DU) or a central unit (CU), may communicate with a core network (CN) node, such as an access and mobility management function (AMF) over a backhaul network interface, such as an NG interface. In other examples, a radio unit (RU) may communicate with a DU over a fronthaul network interface, a DU may communicate with a CU over a midhaul network interface, and/or a first CU may communicate with a second CU over an Xn interface, among other examples. In some cases, the first network node and the second network node may exchange application layer configurations to enable communication over the network interface. Accordingly, in cases where a peer network node or a network interface with a peer network node becomes unavailable and then becomes available again, the peer network nodes may need to perform a configuration procedure to exchange the application layer configurations to enable communication over the network interface. However, there may be certain instances in which a peer network node or network interface becoming unavailable should not be treated as an error case that necessitates performing the configuration procedure to exchange application layer configurations.

For example, in a non-terrestrial network (NTN), a satellite orbiting the Earth may communicate with one or more terrestrial nodes. In such cases, a feeder link between the satellite and a terrestrial node (e.g., an NTN gateway) may be disconnected when the orbiting satellite moves outside a service area of the terrestrial node and subsequently reconnected after the orbiting satellite travels around the Earth and re-enters the service area of the terrestrial node. In such cases, one or more lower layers associated with the network interface may transition between available and unavailable states due to the expected movement of the satellite, and the unavailability of the network interface should not be treated as an error case that necessitates a configuration procedure to exchange application layer configurations (e.g., between an on-board RAN node provided on the satellite and a CN node connected to the terrestrial NTN gateway, such as an AMF). In contrast, when the network interface becomes unavailable for other reasons, such as an obstacle blocking a propagation path between the satellite and the terrestrial node, the unavailability of the network interface may be an error or abnormal case. However, a network node may not be aware of when a peer network node or network interface used to communicate with the peer network node is expected to be available or unavailable and/or may be unable to appropriately identify the peer network node to retrieve an application layer configuration when the status of the peer network node or network interface transitions from unavailable to available.

Various aspects relate generally to an availability or unavailability configuration for a peer network node or a network interface used to communicate with the peer network node. Some aspects more specifically relate to techniques to provide a network node with information that indicates an expected unavailability of a peer network node or a network interface used to communicate with the peer network node such that an application layer configuration may be maintained or retained while a state of the peer network node or the network interface is an unavailable state (e.g., when the expected unavailability indicates a transition from an available state to the unavailable state). For example, in some aspects, an information node or assisting node may configure a first network node with information that may indicate when the peer network node or the network interface used to communicate with the peer network node is expected to be available or unavailable. Additionally, or alternatively, the peer network node may provide an indication to the first network node prior to the state of the peer network node or the network interface transitioning from the available state to the unavailable state and/or after the state of the peer network node or the network interface transitions from the unavailable state to the available state. In some aspects, each network node may retain or maintain an application layer configuration associated with the respective peer network node, which may be associated with an identifier, a counter, or other suitable information that may be used as a key or index to retrieve the application layer configuration when the peer network node or network interface becomes available again (e.g., due to a satellite moving around the Earth and re-entering the service area of a terrestrial node). Furthermore, some aspects described herein relate to techniques to recover from an error case when a network node detects that the peer network node has not retained the application layer configuration.

Particular aspects of the subject matter described in this disclosure can be implemented to realize one or more of the following potential advantages. In some examples, by providing a network node with information that indicates an expected unavailability of a peer network node or a network interface used to communicate with the peer network node, the described techniques can be used to avoid triggering a procedure to recover from an error case when the peer network node or network interface is expected to be unavailable, which may conserve processing resources and/or power resources of the network node and/or the peer network node. Furthermore, by enabling each network node to appropriately identify the peer network node when the peer network node or network interface transitions from the unavailable state to the available state, the peer network node may avoid having to perform a setup or configuration procedure to exchange application layer configurations, which may reduce latency and/or signaling overhead.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

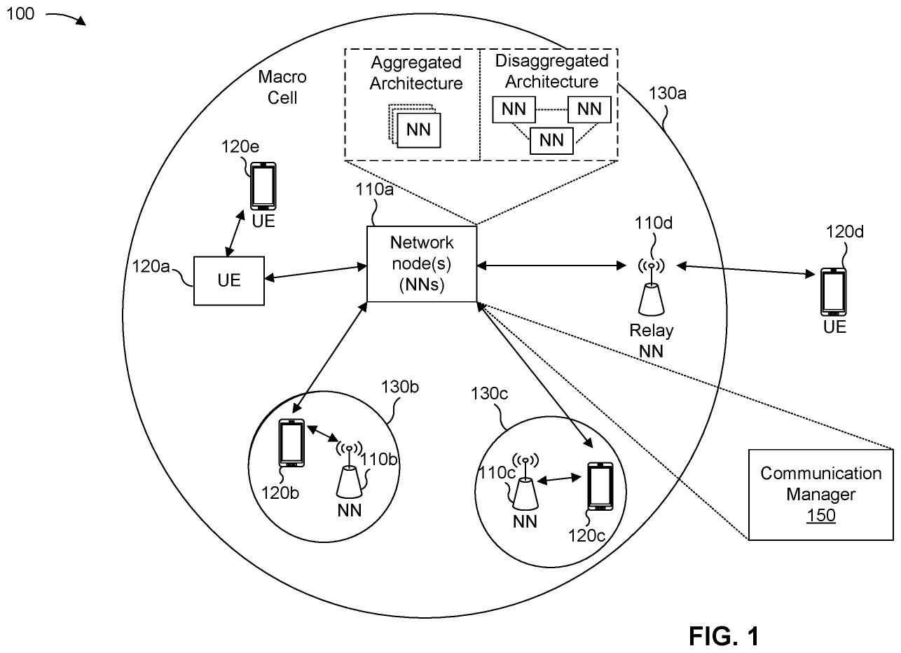

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more RUs. A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core AMF. An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

As indicated above, a network node 110 may be a terrestrial network node 110 (for example, a terrestrial base station or entity of a disaggregated base station) or an NTN node 110. For example, the wireless communication network 100 may include one or more NTN deployments including an NTN node, an NTN node 110, and/or a relay station. In some examples, a relay station in an NTN deployment may be referred to as a “non-terrestrial relay station.” An NTN may facilitate access to the wireless network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN node 110 may communicate directly and/or indirectly with other entities in the wireless network 100 using NTN communication. The other entities may include UEs 120, other NTN nodes 110 in the one or more NTN deployments, other types of network nodes 110 (for example, stationary, terrestrial, and/or ground-based network nodes), relay stations, and/or one or more components and/or devices included in or coupled with a core network of the wireless network 100. For example, an NTN node 110 may communicate with a UE 120 via a service link (for example, where the service link includes an access link). Additionally or alternatively, an NTN node 110 may communicate with a gateway (for example, a terrestrial node providing connectivity for the NTN node 110 to a data network or a core network) via a feeder link (for example, where the feeder link is associated with an N2 or an N3 interface). Additionally or alternatively, a first NTN node 110 may communicate directly with a second NTN node 110 via an inter-satellite link (ISL). An NTN deployment may be transparent (for example, where the NTN node 110 operates in a similar manner as a repeater or relay and/or where an access link does not terminate at the NTN node 110) or regenerative (for example, where the NTN node 110 regenerates a signal and/or where an access link terminates at the NTN node 110).

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a first network node (e.g., a RAN node, such as a CU or a DU, or a CN node, such as an AMF) may include a communication manager 150. As described in more detail elsewhere herein, the communication manager 150 may receive information that indicates an expected unavailability of a second network node or a network interface between the first network node and the second network node; determine, in accordance with the received information, that a state of the second network node or the network interface between the first network node and the second network node is an unavailable state; and maintain an application layer configuration associated with the second network node or the network interface while the state of the second network node or the network interface is the unavailable state. Additionally, or alternatively, the communication manager 150 may perform one or more other operations described herein.

As indicated above, FIG. 1 is provided as an example. Other examples may differ from what is described with regard to FIG. 1.

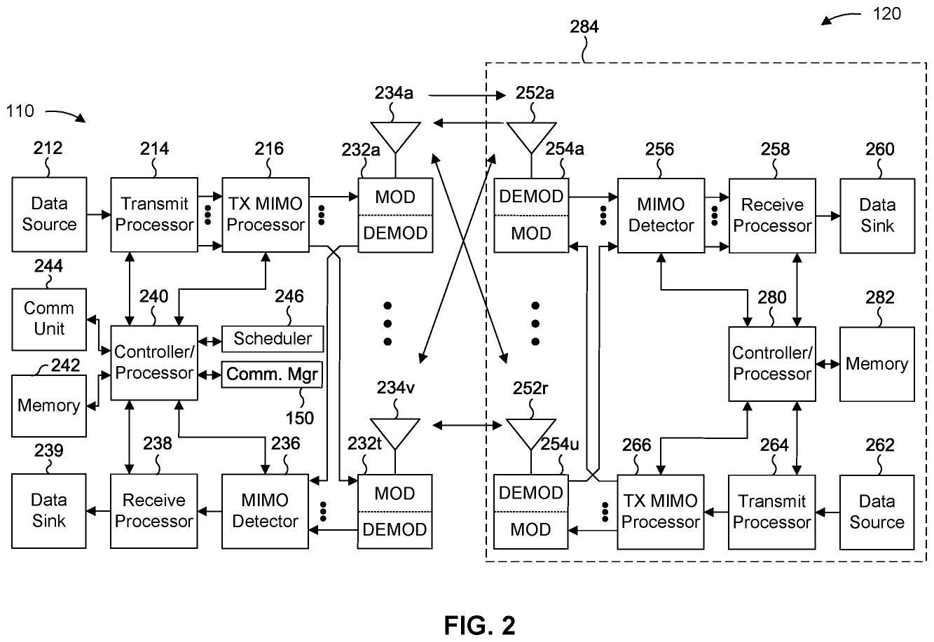

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, and/or a memory 282, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

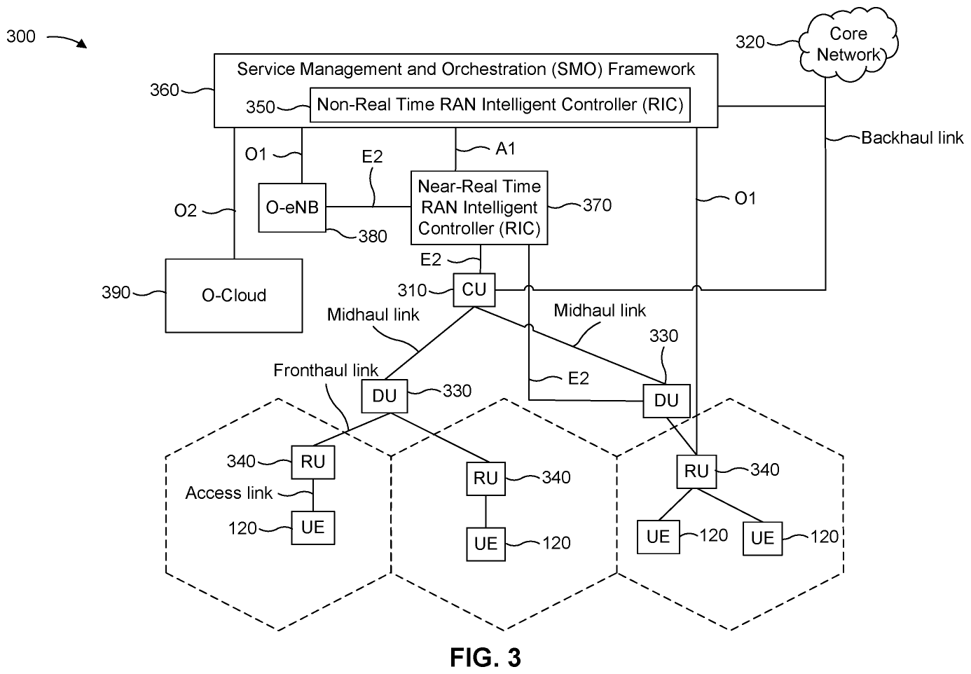

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

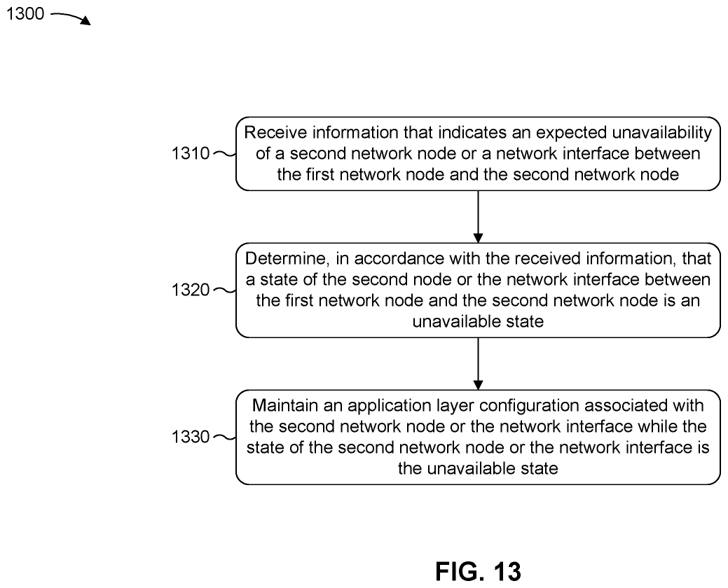

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with network interface unavailability configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13 or other processes as described herein. In some examples, executing instructions may include running the instructions, converting the instructions, compiling the instructions, and/or interpreting the instructions, among other examples.

In some aspects, a first network node (e.g., a RAN node, such as a CU or a DU, or a CN node, such as an AMF) includes means for receiving information that indicates an expected unavailability of a second network node or a network interface between the first network node and the second network node; means for determining, in accordance with the received information, that a state of the second network node or the network interface between the first network node and the second network node is an unavailable state; and/or means for maintaining an application layer configuration associated with the second network node or the network interface while the state of the second network node or the network interface is the unavailable state. The means for the first network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

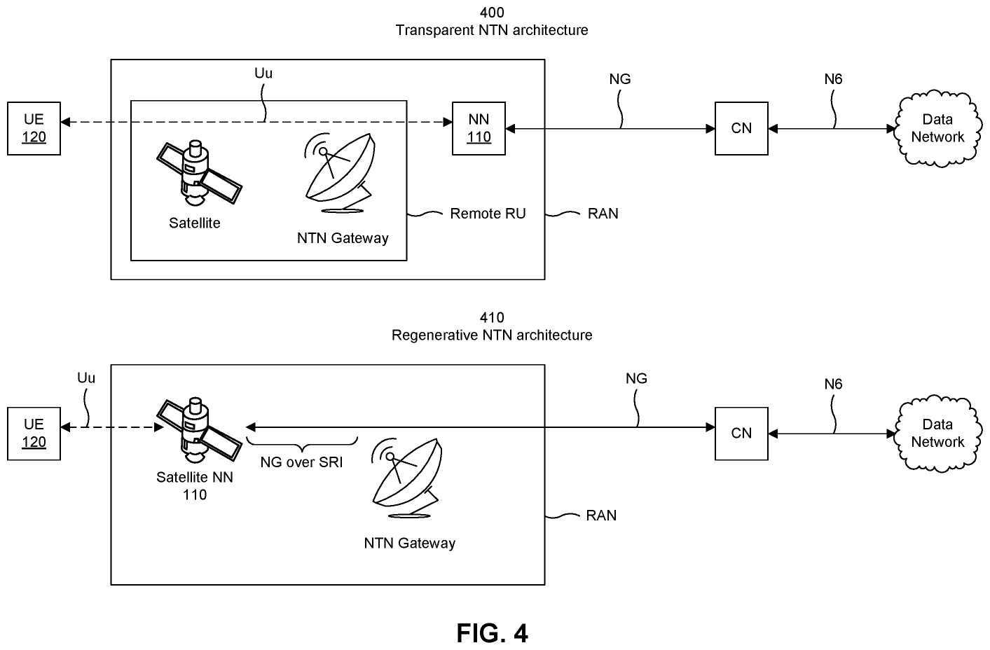

FIG. 4 is a diagram illustrating examples 400 and 410 of NTN architectures, in accordance with the present disclosure. In particular, as described herein, example 400 corresponds to an NTN architecture with a transparent satellite deployment and example 410 corresponds to an NTN architecture with a regenerative satellite deployment.

In some aspects, the UE 120 shown in example 400 and the UE 120 shown in example 410 may be equipped with global navigation satellite system (GNSS) capabilities, such as a global positioning system (GPS) capability, although not all UEs 120 have such capabilities. In examples 400 and 410, the satellite may provide a cell that covers the UE 120, may communicate with the UE 120 via a service link, which may include an uplink and/or a downlink, and may communicate with an NTN gateway via a feeder link, which may include an uplink (e.g., from the UE 120 to the gateway) and/or a downlink (e.g., from the NTN gateway to the UE 120).

In some aspects, as shown by example 400, an NTN architecture may include a transparent satellite deployment, which may also be referred to as a bent-pipe satellite deployment. For example, in the transparent satellite deployment, a terrestrial network node 110 (e.g., a CU or a DU) may use an NG interface to communicate with one or more devices (e.g., an AMF) in a core network that transfers user plane data to and/or from a data network via an N6 interface, and a satellite and an NTN gateway may provide a remote RU to relay signals between a UE 120 and the terrestrial network node 110. Accordingly, in the transparent satellite deployment, the UE 120 communicates with the satellite via a service link, the satellite communicates with the NTN gateway via a feeder link, and an access link or Uu interface terminates at the terrestrial network node 110. For example, in some aspects, the satellite may receive a signal from the UE 120 via the service link, and may relay the signal to the NTN gateway via the feeder link. Similarly, the satellite may receive a signal from the NTN gateway via the feeder link, and may relay the signal to the UE 120 via the service link. For example, the satellite may relay uplink and/or downlink RF transmissions without demodulating the RF transmissions. Additionally, or alternatively, the satellite may perform frequency conversion for RF transmissions that are received from the NTN gateway over the feeder link and forwarded to the UE 120 over the service link, may perform frequency conversion for RF transmissions that are received from the UE 120 over the feeder link and forwarded to the NTN gateway over the feeder link, and/or may amplify and/or filter the transmissions that are relayed between the UE 120 and the NTN gateway.

Additionally, or alternatively, as shown by example 410, an NTN architecture may include a regenerative satellite deployment, which may also be referred to as an on-board satellite deployment or the like. For example, in the regenerative satellite deployment, a satellite includes an on-board network node 110 (e.g., a CU or a DU) that may use an NG interface to communicate with one or more devices (e.g., an AMF) in the core network, and the satellite may communicate with an NTN gateway via a feeder link associated with an NG over satellite radio interface (SRI). Accordingly, in the regenerative satellite deployment, the UE 120 communicates with the satellite via a service link, the satellite communicates with the NTN gateway via a feeder link, and an access link or Uu interface terminates at the network node 110 on-board the satellite. Accordingly, in some aspects, the satellite in the regenerative satellite deployment may be referred to as an NTN node 110, a regenerative repeater, and/or an on-board processing repeater. In the regenerative satellite deployment, the satellite may demodulate a received RF signal (e.g., an uplink RF signal received over the service link or a downlink RF signal received over the feeder link) and may modulate a baseband signal derived from the received RF signal to generate a transmitted RF signal (e.g., an uplink RF signal transmitted to the NTN gateway over the feeder link or a downlink RF signal transmitted to the UE 120 the service link).

In some aspects, in the transparent NTN architecture and the regenerative NTN architecture, the feeder link between the satellite and the NTN gateway and the service link between the satellite and the UE 120 may experience Doppler effects due to movement of the satellite and/or movement of the UE 120. The Doppler effects in an NTN architecture may be significantly larger than in a terrestrial network. The Doppler effect on the feeder link may be compensated for to some degree, but may still be associated with some uncompensated frequency error. Furthermore, the NTN gateway may be associated with a residual frequency error, and/or the satellite may be associated with an on-board frequency error. These sources of frequency error may cause a received downlink frequency at the UE 120 to drift from a target downlink frequency.

As indicated above, FIG. 4 is provided as an example. Other examples may differ from what is described with regard to FIG. 4.

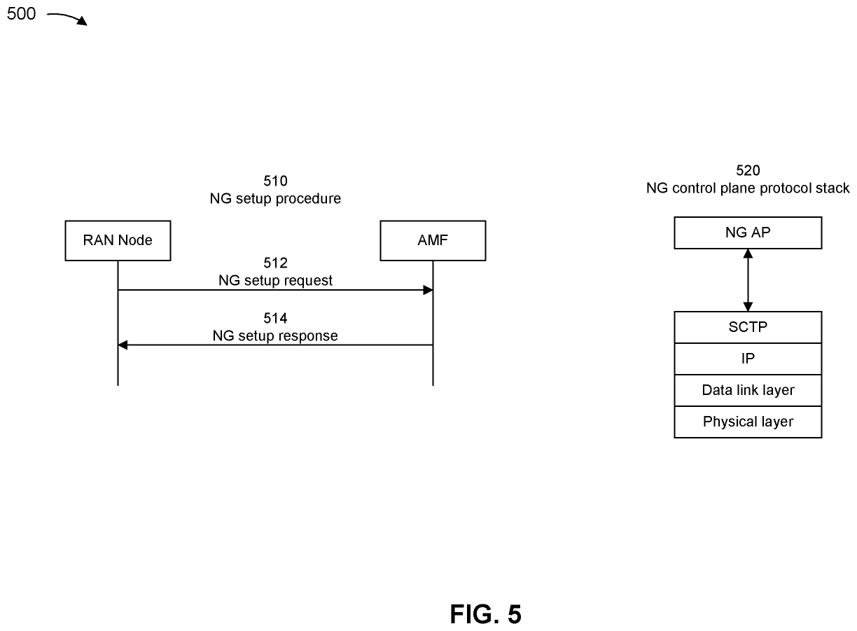

FIG. 5 is a diagram illustrating an example 500 of a backhaul network interface configuration, in accordance with the present disclosure. For example, in FIG. 5, the backhaul network interface may correspond to an NG interface between a RAN node and a CN node, such as an AMF. For example, from a logical perspective, the NG interface may correspond to a point-to-point interface between a RAN node and a CN node that enables an exchange of signaling information between a RAN that includes the RAN node and a core network that includes the CN node. As described herein, the NG interface may support procedures to establish, maintain, and release a RAN portion of a protocol data unit (PDU) session, procedures to perform intra-RAT and/or inter-RAT handovers, separation of different UEs on a protocol level for user-specific signaling management, transferring non-access stratum (NAS) signaling messages between a UE and the AMF, and/or mechanisms to reserve resources for packet data streams, among other examples.

As shown in FIG. 5, a RAN node and an AMF may perform an NG setup procedure 510 to exchange application level data needed for the RAN node and the AMF to correctly interoperate on am NG control plane (NG-C) interface. For example, the NG setup procedure 510 may be the first NG application protocol (NGAP) procedure that is triggered after a transport network layer (TNL) association between the RAN node and the AMF has become operational. In some aspects, as described herein, the NG setup procedure 510 may use non-UE associated signaling.

Furthermore, the NG setup procedure 510 may erase any existing application level (or application layer) configuration data in the RAN node and the AMF, and may replace the existing application level configuration with a new application level configuration that is exchanged during the NG setup procedure 510. Furthermore, the NG setup procedure 510 may clear AMF overload state information at the RAN node, may be used to reinitialize any NGAP UE-related contexts in cases where the RAN node and the AMF do not agree on retaining the UE contexts, and/or may erase all related signaling connections in the RAN node and the AMF (e.g., like an NG reset procedure).

As shown in FIG. 5, and by reference number 512, the NG setup procedure 510 may be initiated when the RAN node sends, to the AMF, an NG setup request message that includes the appropriate information to transfer application layer configuration information for an NG-C interface instance from the RAN node to the AMF. For example, in some aspects, the NG setup request message may include one or more information elements (IEs) that indicate application layer configuration parameters such as one or more identities and/or names associated with the RAN node (e.g., a global RAN node ID, a RAN node name, and/or an extended RAN node name), one or more capabilities associated with the RAN node (e.g., support for one or more RATs, a discontinuous reception (DRX) cycle, network slices, and/or a non-public network (NPN), among other examples), and/or one or more configurations associated with the RAN node (e.g., a tracking area code, UE retention information, and/or a default paging DRX cycle, among other examples).

As further shown in FIG. 5, and by reference number 514, the AMF may send, to the RAN node, an NG setup response message in response to the NG setup request message, where the NG setup response message includes the appropriate information to transfer application layer configuration information for an NG-C interface instance from the AMF to the RAN node. For example, in some aspects, the NG setup response message may include one or more IEs that indicate application layer configuration parameters such as one or more identities and/or names associated with the AMF (e.g., an AMF name, a globally unique AMF ID (GUAMI), and/or an extended AMF name), one or more capabilities associated with the AMF (e.g., support for one or more RATs, a discontinuous reception (DRX) cycle, network slices, and/or IAB communication, among other examples), and/or one or more configurations associated with the AMF.

In this way, the NG setup procedure 510 may be used to provide an application layer configuration for the RAN node to the AMF and to provide an application layer configuration for the AMF to the RAN node, which may enable the AMF and the RAN node to interoperate on an NG-C interface. For example, as shown in FIG. 5, an NG control plane protocol stack 520 includes a physical layer, a data link layer built on top of the physical layer, an Internet protocol (IP) layer built on top of the data layer, and a transport network layer built on the IP transport. For example, as shown, the NG control plane protocol stack 520 may include a stream control transport protocol (SCTP) on top of the IP transport to ensure that signaling messages between the AMF and the RAN node are reliably transported. Furthermore, as shown, the application layer signaling protocol between the AMF and the RAN node is referred to as an NG application protocol (NGAP). For example, NGAP services may include UE-associated services that are related to one UE (e.g., associated with a UE-associated signaling connection that is maintained for a UE in question) and non UE-associated services that relate to a whole NG interface instance between the RAN node and the AMF.

As indicated above, FIG. 5 is provided as an example. Other examples may differ from what is described with regard to FIG. 5.

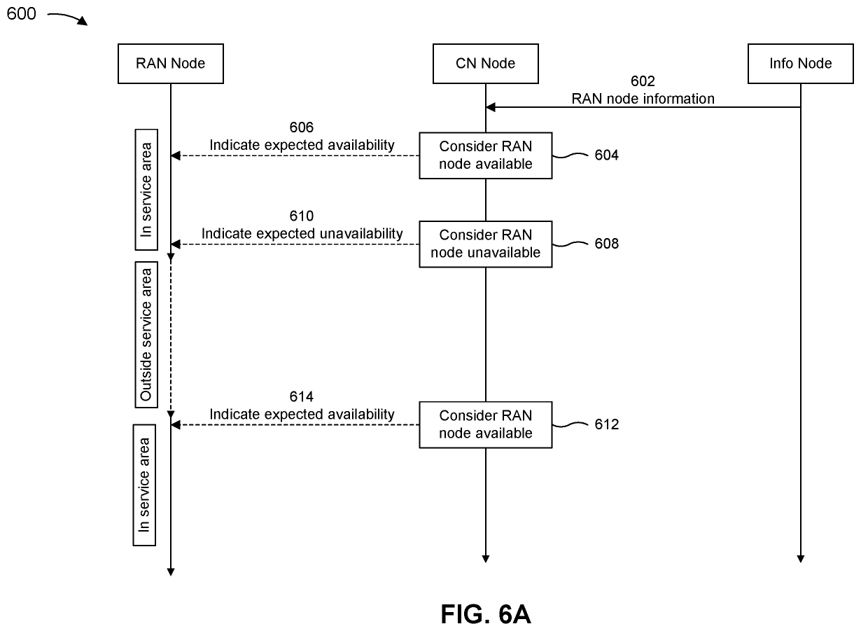

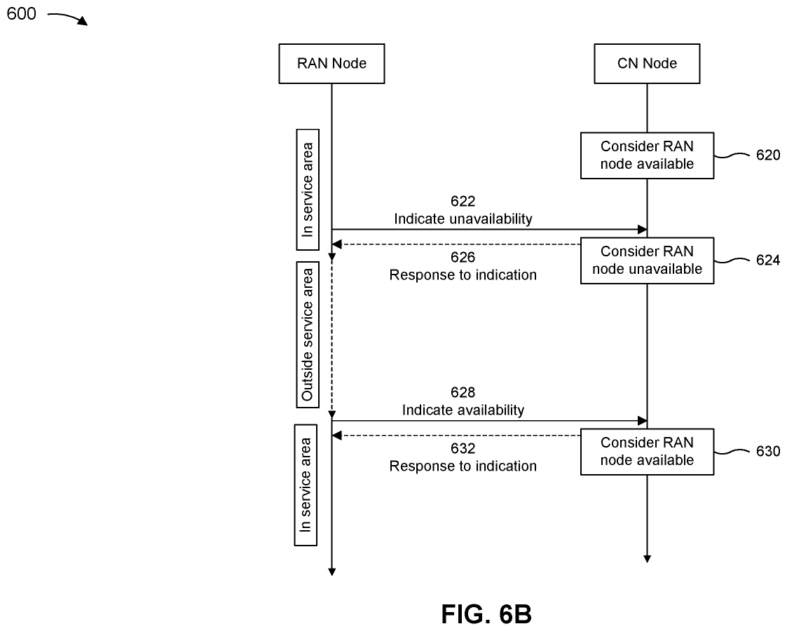

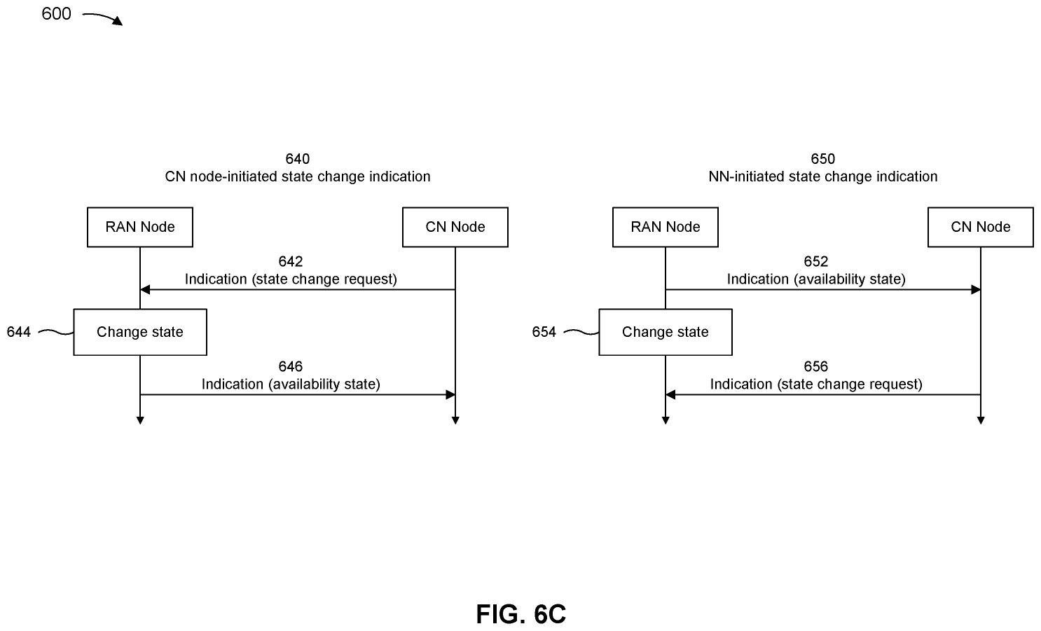

FIGS. 6A-6C are diagrams illustrating examples 600 associated with configuring a CN node with information that indicates an expected availability status for a RAN node, in accordance with the present disclosure. As shown in FIGS. 6A-6C, examples 600 include communication between a CN node, such as an AMF, and a RAN node, such as a gNB or a DU or a CU of the gNB. In some aspects, the RAN node may communicate with the CN node via an NG interface. Furthermore, in some aspects, the RAN node may be deployed on a satellite in an NTN architecture. Accordingly, in some aspects, a terrestrial NTN gateway (not explicitly shown in FIGS. 6A-6C) may relay communications between the RAN node and the CN node. Furthermore, as shown in FIG. 6A, examples 600 may include communication between the CN node and an information node. Although examples 600 may be described in a context related to communication between a satellite-based RAN node and an AMF in an NTN architecture, the techniques described herein may be applied to any suitable network nodes and/or network interfaces with scheduled, configured, predictable, or otherwise expected transitions between available and unavailable states.

In some aspects, as shown by reference number 602, the information node may send, and the CN node may receive, information associated with the RAN node. For example, in some aspects, the information node may correspond to an operations, administration, and maintenance (OAM) device, another CN node, an NTN gateway, a cloud server, a node that is co-located with the CN node, or any other suitable node with access to information associated with the RAN node. In some aspects, the information node may provide the information associated with the RAN node to the CN node at periodic intervals and/or in response to the CN node requesting the information associated with the RAN node.

In some aspects, as described herein, the information associated with the RAN node may generally indicate and/or may enable the CN node to determine an expected availability and/or an expected unavailability of the RAN node and/or a network interface between the RAN node and the CN node. For example, in an NTN architecture where the RAN node is provided on-board a satellite, the information that the CN node receives from the information node may include satellite information, such as ephemeris information and/or information related to when the satellite and the on-board RAN node is expected to be available or unavailable. For example, the expected availability and/or the expected unavailability may be indicated according to an absolute time or a relative time from a reference time, according to location information (e.g., an absolute location, such as a latitude, longitude, and/or altitude), and/or a relative distance from a reference point. Furthermore, in some aspects, the information associated with the RAN node may include identity information associated with the RAN node, such as a satellite identifier, a RAN node identifier, a feeder link identifier, a tracking area identifier, a public land mobile network (PLMN) identifier, and/or a cell identifier, among other examples. Additionally, or alternatively, the expected availability and/or the expected unavailability of the RAN node or the network interface associated with the RAN node may be indicated according to one or more state parameters (e.g., activated or deactivated, resumed or suspended, or the like).

In this way, the information that the CN node receives from the information node may indicate or may enable the CN node to determine when the RAN node or the network interface associated with the RAN node is expected to be available and/or when the RAN node or the network interface associated with the RAN node is expected to be unavailable (e.g., due to a satellite moving outside and/or re-entering the service area associated with an NTN gateway or other terrestrial node (not shown in FIG. 6A) that facilitates communication between the RAN node and the CN node). In some aspects, the CN node may maintain the information indicating the expected availability and/or the expected unavailability of the RAN node and/or the network interface associated with the RAN node for different identifiers. For example, in some aspects, the CN node may maintain the information indicating the expected availability and/or the expected unavailability of the RAN node and/or the network interface associated with the RAN node per satellite, per feeder link identity, per network node, per network node endpoint, per CU, per DU, per RU, per tracking area, per cell, per cell group, per beam, per service area, per emergency area, per multicast-broadcast service (MBS) area, per frequency, per RAT, per PLMN, per endpoint, and/or per service, among other examples.

Accordingly, in some aspects, the CN node may maintain an availability or unavailability state for the RAN node internally and may use a time-to-trigger (TTT) parameter to determine when the state is expected to change from available to unavailable or from unavailable to available. Furthermore, as described herein, the CN node may use the TTT parameter to ensure that the state of the RAN node appropriately transitions when expected (e.g., due to the satellite leaving or entering the service area of the NTN gateway). For example, as shown by reference number 604, the CN node may determine that the RAN node is expected to be available in accordance with the information provided by the information node (e.g., indicating that the satellite is within the service area of the NTN gateway). In some aspects, as shown by reference number 606, the CN node may optionally send, to the RAN node, a message indicating that the RAN node is expected to be available. Additionally, or alternatively, the CN node may send the message indicating that the RAN node is expected to be available to another network node (not shown in FIG. 6A), such as a user plane function (UPF).

As further shown by reference number 608, the CN node may subsequently determine that the RAN node is expected to be unavailable in accordance with the information provided by the information node (e.g., in accordance with the TTT parameter indicating that the satellite is moving from in the service area to outside the service area of the NTN gateway). In some aspects, as shown by reference number 610, the CN node may optionally send, to the RAN node, a message indicating that the RAN node is expected to be unavailable. In some aspects, the CN node may send the message indicating that the RAN node is expected to be unavailable prior to the RAN node actually transitioning to the unavailable state. Additionally, or alternatively, the CN node may send the message indicating that the RAN node is expected to be unavailable to another network node (not shown in FIG. 6A), such as a UPF. In some aspects, where the CN node sends the message to a network node other than the RAN node, the CN node may send the message prior to the RAN node leaving the service area of the NTN gateway or after the RAN node has left the service area of the NTN gateway.

As described elsewhere herein, the CN node and/or the RAN node may determine that the unavailability of the RAN node is expected and thus not an error case. The CN node and/or the RAN node may maintain or retain an application layer configuration for the RAN node based on the expectation that the RAN node will re-enter the service area of the NTN gateway.

As further shown by reference number 612, the CN node may subsequently determine that the RAN node is expected to be available in accordance with the information provided by the information node (e.g., in accordance with the TTT parameter indicating that the satellite is re-entering the service area of the NTN gateway). In some aspects, as shown by reference number 614, the CN node may optionally send, to the RAN node, a message indicating that the RAN node is expected to be available. In some aspects, the CN node may send the message indicating that the RAN node is expected to be available after the RAN node actually transitions to the available state. Additionally, or alternatively, the CN node may send the message indicating that the RAN node is expected to be available to another network node (not shown in FIG. 6A), such as a UPF.

In some aspects, the TTT parameter that the CN node uses to track expected changes to the availability status of the RAN node or the network interface associated with the RAN node may be configured by the information node, and different values may be configured for the TTT parameter for when the state of the RAN node or the network interface is expected to transition from available to unavailable (e.g., due to the satellite moving outside the service area) and when the state of the RAN node or the network interface is expected to transition from unavailable to available (e.g., due to the satellite re-entering the service area). For example, a time period during which a satellite is within the service area of an NTN gateway may differ from a time period during which the satellite is outside the service area of an NTN gateway. Furthermore, in some aspects, the RAN node or the network interface may be associated with a default state (e.g., either available or unavailable), which may be preconfigured or hard-coded (e.g., according to a wireless communication standard). In this way, when the RAN node or the network interface associated with the RAN node is in the unavailable state, the CN node may maintain an application layer configuration associated with the network interface if the RAN node or the network interface associated with the RAN node is expected to be in the unavailable state. In some aspects, when the CN node determines that the state of the RAN node or the network interface associated with the RAN node is expected to be the unavailable state, the CN node may prohibit or otherwise not trigger certain procedures associated with the network interface (e.g., may suspend UE-associated procedures) other than certain procedures that relate to managing the network interface (e.g., an NG reset procedure and/or a procedure to resume communication over the NG interface).

FIG. 6B illustrates aspects that may be in addition to, or alternatives to, the aspects illustrated in FIG. 6A. As shown in FIG. 6B, the CN node may receive an indication when the state of the RAN node or the network interface associated with the RAN node changes from available to unavailable and/or from unavailable to available. For example, as shown by reference number 620, the CN node may initially determine that the state of the RAN node or the network interface associated with the RAN node is an available state (e.g., based on the CN node and the RAN node successfully exchanging an application layer configuration associated with the network interface, such as in an NG setup procedure that is performed while the RAN node is within a service area associated with the CN node). In some aspects, as shown by reference number 622, the CN node may then receive an indication when the state of the RAN node or the network interface associated with the RAN node is transitioning to the unavailable state. As shown by reference number 624, the CN node may then consider the state of the RAN node or the network interface associated with the RAN node to be the unavailable state. As shown by reference number 626, the CN node may optionally send a response to acknowledge the indication (e.g., while the RAN node is still in the service area of the NTN gateway). Similarly, as shown by reference number 628, the CN node may receive an indication when the state of the RAN node or the network interface associated with the RAN node is transitioning back to the available state (e.g., due to the satellite re-entering the service area). As shown by reference number 630, the CN node may then consider the state of the RAN node or the network interface associated with the RAN node to be the available state. As shown by reference number 632, the CN node may optionally send a response to acknowledge the indication.

In some aspects, as shown in FIG. 6B, the CN node may receive the indication that the state of the RAN node or the network interface associated with the RAN node is transitioning from the available state or vice versa from the RAN node, and may send the response to acknowledge the indication to the RAN node. Additionally, or alternatively, in some aspects, the indication may be received from and the response message may be transmitted to a satellite associated with the RAN node, another CN node, an OAM device, and/or a cloud server, among other examples. Furthermore, in some aspects, the indication of the state change from available to unavailable or unavailable to available may be sent when a triggering event occurs, where the triggering event may include a satellite moving outside or re-entering a service area of an NTN gateway, a configured timing, a satellite arriving at or passing through a specific location, and/or expiration of a periodic timer. In some aspects, the state change indication may be carried in a message associated with a procedure related to the network interface (e.g., a RAN configuration update) or a separate message.

In some aspects, the indication related to the state of the RAN node or the network interface associated with the RAN node may include information related to an identity of the RAN node, a satellite associated with the RAN node, a RAN node endpoint, a feeder link, an NTN gateway, an endpoint associated with the NTN gateway, a proxy node, an endpoint associated with the proxy node, the CN node, and/or an endpoint associated with the CN node. Furthermore, the state of the RAN node or the network interface associated with the RAN node may be indicated directly (e.g., with a first value, such as 0, indicating unavailable and a second value, such as 1, indicating availability). Additionally, or alternatively, the state of the RAN node or the network interface associated with the RAN node may be indicated indirectly (e.g., one or more parameters associated with the RAN node may modified such that the CN node does not trigger a procedure or send a message to the RAN node). For example, in some aspects, tracking area (TA) information associated with the RAN node may be changed to a value that is not within or otherwise relevant to a service area associated with the CN node). Additionally, or alternatively, the state of the RAN node or the network interface associated with the RAN node may be indicated according to a suitable parameter (e.g., activated or deactivated, resumed or suspended, or the like), and may be maintained per satellite, per feeder link identity, per network node, per network node endpoint, per CU, per DU, per RU, per tracking area, per cell, per cell group, per beam, per service area, per emergency area, per MBS area, per frequency, per RAT, per PLMN, per endpoint, and/or per service, among other examples. In some aspects, the indication may include information related to an expected or estimated time duration for the indicated state (e.g., a deactivated or unavailable RAN node may indicate that the state will remain deactivated or unavailable for 1 hour or another suitable time period), an expected or estimated location for the indicated state (e.g., indicated according to an absolute location or a relative distance from a reference point), and/or expected time until a next state change (e.g., a deactivated or unavailable RAN node may indicate an absolute time when the RAN node is next expected to transition to an activated or available state).

In some aspects, as described herein, the CN node may receive the indication related to the change to the state associated with the RAN node or the network interface associated with the RAN node from the RAN node or another suitable node.

Alternatively, in some aspects, the CN node may initiate the change to the state associated with the RAN node or the network interface associated with the RAN node. For example, referring to FIG. 6C, reference number 640 corresponds to an example procedure in which the CN node initiates the change to the state associated with the RAN node or the network interface associated with the RAN node. For example, as shown by reference number 642, the CN node may send, to the RAN node, an indication that includes a state change request. As shown by reference number 644, the RAN node may then change a state from available to unavailable or from unavailable to available. As shown by reference number 646, the RAN node may then send a response message indicating the resulting (un) availability state to the CN node. Alternatively, reference number 650 corresponds to an example procedure in which the RAN node initiates the change to the state associated with the RAN node or the network interface associated with the RAN node. For example, as shown by reference number 652, the RAN node may send, to the CN node, an indication of a current state or an expected state change. As shown by reference number 654, the RAN node may then change a state from available to unavailable or from unavailable to available in accordance with the indication. As shown by reference number 656, the CN node may then send, to the RAN node, an indication that includes a request to change the state of the RAN node or the network interface associated with the RAN node from available to unavailable or from unavailable to available. For example, in some aspects, the RAN node may send a RAN configuration update or another suitable message (e.g., to change TA information or to inform the CN node of the current state or an expected state change), and the CN node may send a RAN configuration update response or another suitable message to indicate the state change request. If the CN node does not respond to the indication from the RAN node, the RAN node may change or maintain the state of the RAN node or the network interface associated with the RAN node.

As indicated above, FIGS. 6A-6C are provided as examples. Other examples may differ from what is described with regard to FIGS. 6A-6C.

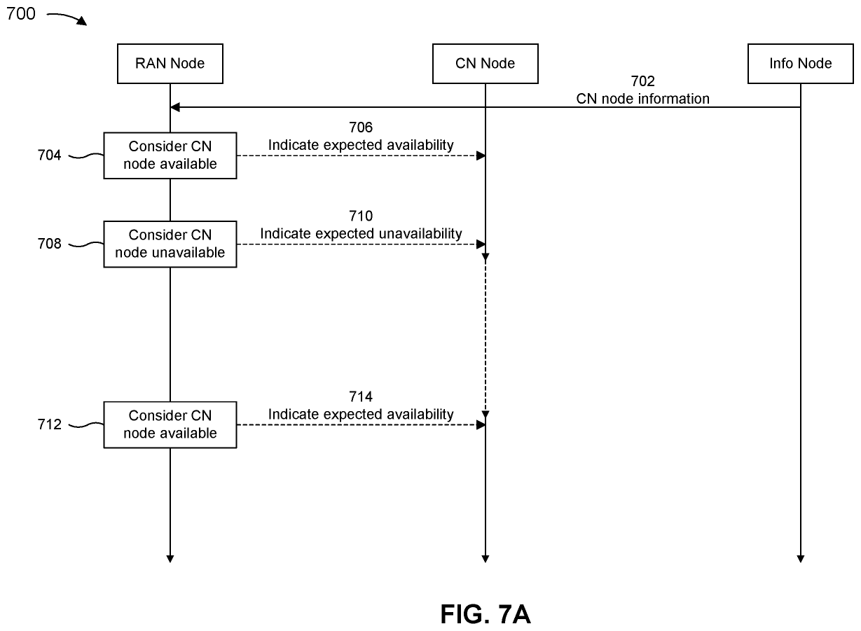

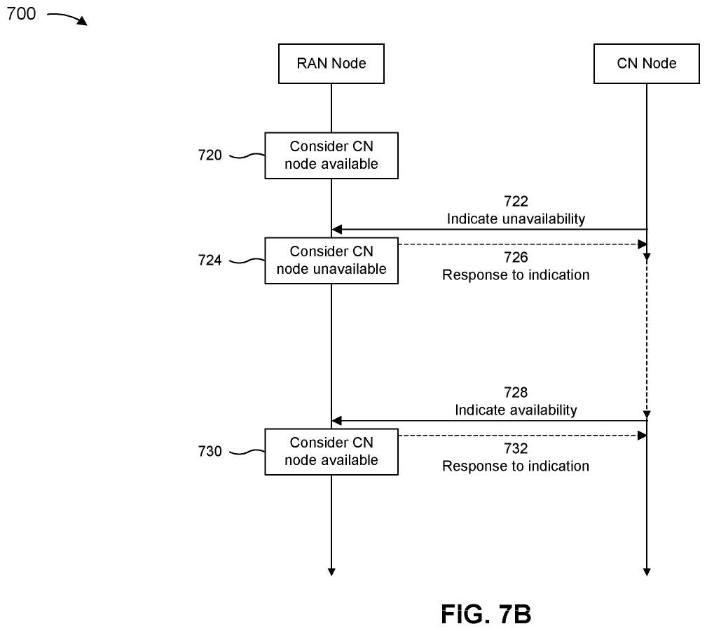

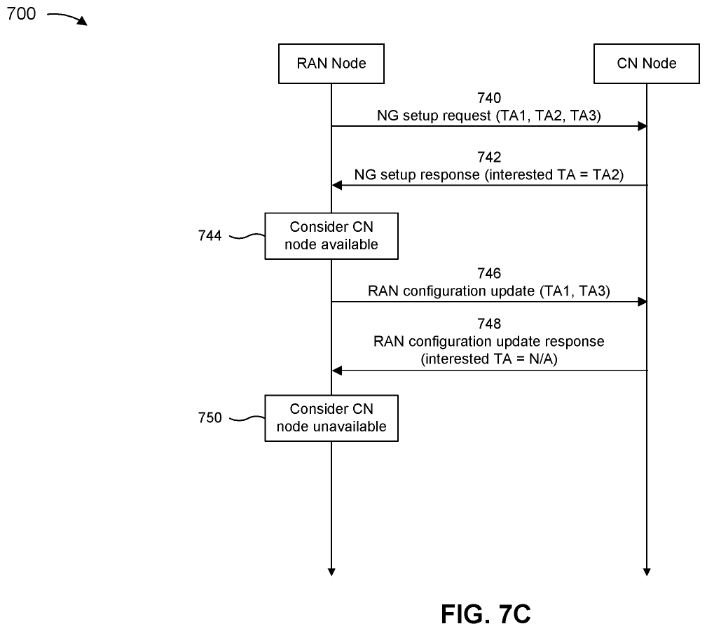

FIGS. 7A-7C are diagrams illustrating examples 700 associated with configuring a RAN node with information that indicates an expected availability status for a CN node, in accordance with the present disclosure. As shown in FIGS. 7A-7C, examples 700 include communication between a CN node, such as an AMF, and a RAN node, such as a DU or a CU. In some aspects, the RAN node may communicate with the CN node via an NG interface. Furthermore, in some aspects, the RAN node may be deployed on a satellite in an NTN architecture. Accordingly, in some aspects, a terrestrial NTN gateway (not explicitly shown in FIGS. 7A-7C) may relay communications between the RAN node and the CN node. Furthermore, as shown in FIG. 7A, examples 700 may include communication between the CN node and an information node. Although examples 700 may be described in a context related to communication between a satellite-based RAN node and an AMF in an NTN architecture, the techniques described herein may be applied to any suitable network nodes and/or network interfaces with scheduled, configured, predictable, or otherwise expected transitions between available and unavailable states.

In some aspects, as shown by reference number 702, the information node may send, and the RAN node may receive, information associated with the CN node. For example, in some aspects, the information node may correspond to an OAM device, another CN node, an NTN gateway, a proxy node, a cloud server, a node that is co-located with the CN node, or any other suitable node with access to information associated with the CN node. In some aspects, the information node may provide the information associated with the CN node to the RAN node at periodic intervals and/or in response to the RAN node requesting the information associated with the CN node.

In some aspects, as described herein, the information associated with the CN node may generally indicate and/or may enable the RAN node to determine an expected availability and/or an expected unavailability of the CN node and/or a network interface between the CN node and the RAN node. For example, in an NTN architecture where the RAN node is provided on-board a satellite, the information that the RAN node receives from the information node may information related to when the CN node or the network interface associated with the CN node is expected to be available or unavailable (e.g., due to a satellite associated with the RAN node moving outside a service area of an NTN gateway). For example, the expected availability and/or the expected unavailability may be indicated according to an absolute time or a relative time from a reference time, according to location information (e.g., an absolute location and/or a relative location of the CN node, an endpoint associated with the CN node, a proxy node, an endpoint associated with the proxy node, the NTN gateway, and/or an endpoint associated with the NTN gateway). Furthermore, in some aspects, the information associated with the CN node may include identity information associated with the CN node, an endpoint associated with the CN node, a proxy node, an endpoint associated with the proxy node, the NTN gateway, and/or an endpoint associated with the NTN gateway, among other examples. Additionally, or alternatively, the expected availability and/or the expected unavailability of the CN node or the network interface associated with the CN node may be indicated according to one or more state parameters (e.g., activated or deactivated, resumed or suspended, or the like).

In this way, the information that the RAN node receives from the information node may indicate or may enable the RAN node to determine when the CN node or the network interface associated with the CN node is expected to be available and/or when the CN node or the network interface associated with the CN node is expected to be unavailable (e.g., due to a satellite associated with the RAN node moving outside and/or re-entering the service area associated with an NTN gateway or other terrestrial node that facilitates communication between the RAN node and the CN node). In some aspects, the RAN node may maintain the information indicating the expected availability and/or the expected unavailability of the CN node and/or the network interface associated with the CN node for different identifiers. For example, in some aspects, the RAN node may maintain the information indicating the expected availability and/or the expected unavailability of the CN node and/or the network interface associated with the CN node per CN node, per CN node endpoint, per AMF, per PLMN, per endpoint, and/or per service, among other examples.

Accordingly, in some aspects, the RAN node may maintain an availability or unavailability state for the CN node internally and may use a TTT parameter to determine when the state is expected to change from available to unavailable or from unavailable to available. Furthermore, as described herein, the RAN node may use the TTT parameter to ensure that the state of the CN node appropriately transitions when expected (e.g., due to the satellite associated with the RAN node leaving or entering the service area of the NTN gateway). For example, as shown by reference number 704, the RAN node may determine that the CN node is expected to be available in accordance with the information provided by the information node (e.g., while a satellite associated with the RAN node is within the service area of the NTN gateway). In some aspects, as shown by reference number 706, the RAN node may optionally send, to the CN node, a message indicating that the CN node is expected to be available. Additionally, or alternatively, the RAN node may send the message indicating that the CN node is expected to be available to another network node.

As further shown by reference number 708, the RAN node may subsequently determine that the CN node is expected to be unavailable in accordance with the information provided by the information node (e.g., in accordance with the TTT parameter indicating that the satellite associated with the RAN node is moving outside the service area of the NTN gateway). In some aspects, as shown by reference number 710, the RAN node may optionally send, to the CN node, a message indicating that the CN node is expected to be unavailable. In some aspects, the RAN node may send the message indicating that the CN node is expected to be unavailable prior to the CN node actually transitioning to the unavailable state. Additionally, or alternatively, the RAN node may send the message indicating that the CN node is expected to be unavailable to another network node.

As further shown by reference number 712, the RAN node may subsequently determine that the CN node is expected to be available in accordance with the information provided by the information node (e.g., in accordance with the TTT parameter indicating that the satellite associated with the RAN node is re-entering the service area of the NTN gateway). In some aspects, as shown by reference number 714, the RAN node may optionally send, to the CN node, a message indicating that the CN node is expected to be available. In some aspects, the RAN node may send the message indicating that the CN node is expected to be available after the CN node actually transitions to the available state (e.g., after the satellite associated with the RAN node re-enters the service area of the NTN gateway coupled to the CN node). Additionally, or alternatively, the RAN node may send the message indicating that the CN node is expected to be available to another network node.

In some aspects, the TTT parameter that the RAN node uses to track expected changes to the availability status of the CN node or the network interface associated with the CN node may be configured by the information node, and different values may be configured for the TTT parameter for when the state of the CN node or the network interface is expected to transition from available to unavailable (e.g., due to the satellite moving outside the service area) and when the state of the CN node or the network interface is expected to transition from unavailable to available (e.g., due to the satellite re-entering the service area). For example, a time period during which a satellite is within the service area of an NTN gateway may differ from a time period during which the satellite is outside the service area of an NTN gateway. Furthermore, in some aspects, the CN node or the network interface may be associated with a default state (e.g., either available or unavailable), which may be preconfigured or hard-coded (e.g., according to a wireless communication standard). In this way, when the CN node or the network interface associated with the CN node is in the unavailable state, the RAN node may maintain an application layer configuration associated with the network interface if the CN node or the network interface associated with the CN node is expected to be in the unavailable state. In some aspects, when the RAN node determines that the state of the CN node or the network interface associated with the CN node is expected to be the unavailable state, the RAN node may prohibit or otherwise not trigger certain procedures associated with the network interface (e.g., may suspend UE-associated procedures) other than certain procedures that relate to managing the network interface (e.g., an NG reset procedure and/or a procedure to resume communication over the NG interface).

Additionally, or alternatively, as shown in FIG. 7B, the RAN node may receive an indication when the state of the CN node or the network interface associated with the CN node changes from available to unavailable and/or from unavailable to available. For example, as shown by reference number 720, the RAN node may initially determine that the state of the CN node or the network interface associated with the CN node is an available state (e.g., based on the CN node and the RAN node successfully exchanging an application layer configuration associated with the network interface, such as in an NG setup procedure that is performed while the RAN node is within a service area associated with the CN node). In some aspects, as shown by reference number 722, the RAN node may then receive an indication when the state of the CN node or the network interface associated with the CN node is transitioning to the unavailable state. As shown by reference number 724, the RAN node may then consider the state of the CN node or the network interface associated with the CN node to be the unavailable state. As shown by reference number 726, the RAN node may optionally send a response to acknowledge the indication. Similarly, as shown by reference number 728, the RAN node may receive an indication when the state of the CN node or the network interface associated with the CN node is transitioning back to the available state (e.g., due to the satellite associated with the RAN node re-entering the service area of an NTN gateway). As shown by reference number 730, the RAN node may then consider the state of the CN node or the network interface associated with the CN node to be the available state. As shown by reference number 732, the RAN node may optionally send a response to acknowledge the indication.

In some aspects, as shown in FIG. 7B, the RAN node may receive the indication that the state of the CN node or the network interface associated with the CN node is transitioning from the available state or vice versa from the CN node, and may send the response to acknowledge the indication to the CN node. Additionally, or alternatively, in some aspects, the indication may be received from and the response message may be transmitted to another RAN node, a satellite associated with another RAN node, another CN node, an OAM device, and/or a cloud server, among other examples. Furthermore, in some aspects, the indication of the state change from available to unavailable or unavailable to available may be sent when a triggering event occurs, where the triggering event may include a satellite associated with the RAN node moving outside or re-entering a service area of an NTN gateway, a configured timing, the satellite arriving at or passing through a specific location, and/or expiration of a periodic timer. In some aspects, the state change indication may be carried in a message associated with a procedure related to the network interface (e.g., a RAN configuration update) or a separate message.

In some aspects, the indication related to the state of the CN node or the network interface associated with the CN node may include information related to an identity of the CN node, an endpoint associated with the CN node, a feeder link, an NTN gateway, a proxy node, an endpoint associated with the proxy node, an endpoint associated with the NTN gateway, the RAN node, an endpoint associated with the RAN node, and/or a satellite associated with the RAN node. Furthermore, the state of the CN node or the network interface associated with the CN node may be indicated directly (e.g., with a first value, such as 0, indicating unavailable and a second value, such as 1, indicating availability). Additionally, or alternatively, the state of the CN node or the network interface associated with the CN node may be indicated indirectly (e.g., one or more parameters associated with the CN node may modified such that the RAN node does not trigger a procedure or send a message to the CN node). Additionally, or alternatively, the state of the CN node or the network interface associated with the CN node may be indicated according to a suitable parameter (e.g., activated or deactivated, resumed or suspended, or the like), and may be maintained per CN node, per feeder link identity, per RAN node, per RAN node or CN node endpoint, per tracking area, per cell, per cell group, per beam, per service area, per emergency area, per MBS area, per frequency, per RAT, per PLMN, per endpoint, and/or per service, among other examples. In some aspects, the indication may include information related to an expected or estimated time duration for the indicated state (e.g., a deactivated or unavailable CN node may indicate that the state will remain deactivated or unavailable for 1 hour or another suitable time period), an expected or estimated location for the indicated state (e.g., indicated according to an absolute location or a relative distance from a reference point), and/or expected time until a next state change (e.g., a deactivated or unavailable CN node may indicate an absolute time when the CN node is next expected to transition to an activated or available state).

In some aspects, as shown in FIG. 7C, the RAN node may implicitly determine whether the state of the CN node or the network interface associated with the CN node is the available state or the unavailable state in accordance with information received from the CN node. For example, as shown by reference number 740, the RAN node may send, to the CN node, an NG setup request message (e.g., during an NG setup procedure) that indicates one or more identifiers associated with PLMNs, RATs, TAS, cell beams, areas, and/or frequencies supported by the RAN node. For example, in FIG. 7C, the NG setup request message sent from the RAN node to the CN node indicates that the RAN node supports TA1, TA2, and TA3. As further shown by reference number 742, the CN node may send, to the RAN node, an NG setup response message (e.g., during the NG setup procedure) that indicates one or more PLMNs, RATs, TAS, cell beams, areas, and/or frequencies that the CN node is interested in. For example, in FIG. 7C, the NG setup response message sent from the CN node to the RAN node indicates that the CN node is interested in TA2. Accordingly, the RAN node may determine that the state of the CN node or the network interface associated with the CN node is the available state if the RAN node supports the PLMNs, RATs, TAs, cell beams, areas, and/or frequencies that the CN node is interested in or may determine that the state of the CN node or the network interface associated with the CN node is the unavailable state if the RAN node does not support the PLMNs, RATs, TAs, cell beams, areas, and/or frequencies that the CN node is interested in. For example, as shown by reference number 744, the RAN node may determine that the state of the CN node or the network interface associated with the CN node is the available state based on the CN node indicated interest in TA2, which is supported by the RAN node.

In some aspects, when the RAN node changes a configuration to enable or disable one or more PLMNs, RATs, TAs, cell beams, areas, and/or frequencies that the CN node is interested in, the RAN node may determine that the state of the CN node or the network interface associated with the CN node has changed from available to unavailable or from unavailable to available. For example, as shown by reference number 746, the RAN node may send a RAN configuration update or another suitable message to indicate that TA1 and TA3 are enabled and that TA2 is disabled. The CN node may then send a response message to the RAN node to indicate whether the CN node is interested in any PLMNs, RATs, TAs, cell beams, areas, and/or frequencies enabled by the RAN node. For example, as shown by reference umber 748, the CN node may send a RAN configuration update response message, an AMF configuration update message, or another suitable message to indicate that the CN node is not interested in any of the TAs enabled by the RAN node. Accordingly, as shown by reference number 750, the RAN node may determine that the state of the CN node or the network interface associated with the CN node is the unavailable state based on the CN node not indicating interest in any of the TAs enabled by the RAN node.

As indicated above, FIGS. 7A-7C are provided as examples. Other examples may differ from what is described with regard to FIGS. 7A-7C.

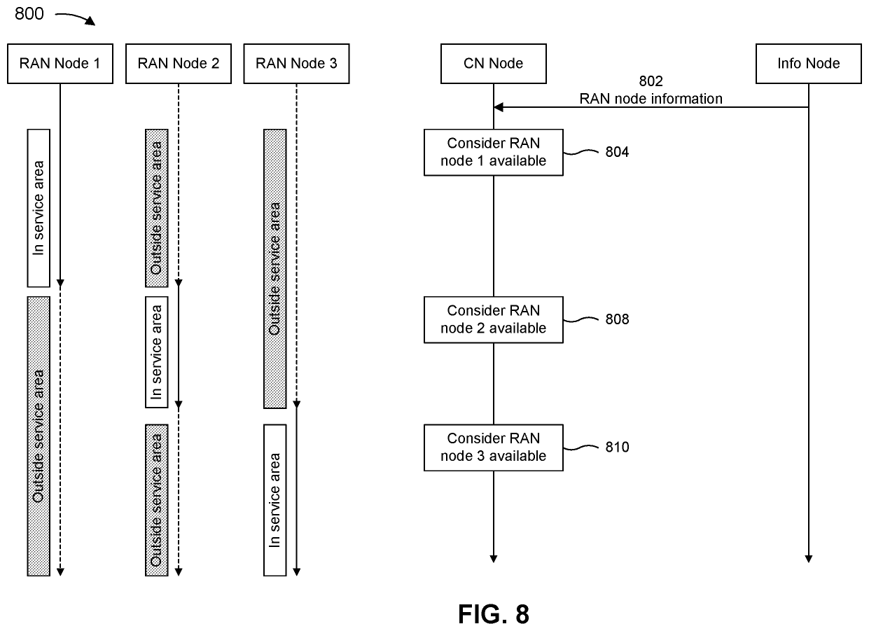

FIG. 8 is a diagram illustrating an example 800 associated with configuring a CN node with information to identify a RAN node associated with an availability status that changes over time, in accordance with the present disclosure. As shown in FIG. 8, example 800 includes communication between a CN node, such as an AMF, and one or more RAN nodes, such as a DU or a CU. In some aspects, the RAN nodes may each communicate with the CN node via an NG interface. Furthermore, in some aspects, the RAN nodes may be deployed on satellites in an NTN architecture. Accordingly, in some aspects, a terrestrial NTN gateway (not explicitly shown in FIG. 8) may relay communications between the RAN nodes and the CN node. Furthermore, as shown in FIG. 8, example 800 includes communication between the CN node and an information node. Although example 800 may be described in a context related to communication between satellite-based RAN nodes and an AMF in an NTN architecture, the techniques described herein may be applied to any suitable network nodes and/or network interfaces with scheduled, configured, predictable, or otherwise expected transitions between available and unavailable states.

In some aspects, as described herein, when the CN node determines that the state associated with a RAN node or a network interface associated with a RAN node is expected to be an unavailable state (e.g., due to a satellite associated with the RAN node being outside a service area associated with an NTN gateway), the CN node may maintain an application layer configuration associated with the RAN node or the network interface associated with the RAN node until the RAN node transitions back to an available state (e.g., due to the satellite associated with the RAN node re-entering the service area associated with an NTN gateway). For example, in some aspects, the CN node may maintain the application layer configuration in cases where the network interface does not support a release procedure (e.g., an NG release procedure) or another suitable procedure to retain the application layer configuration. Accordingly, as described herein, the CN node may store a network interface (e.g., NG) application layer configuration for each RAN node that is expected to transition between available and unavailable states, and vice versa. Accordingly, when the RAN node or the network interface associated with the RAN node transitions from the unavailable state back to the available state (e.g., after the satellite associated with the RAN node has traveled around the Earth and re-enters the service area of an NTN gateway in communication with the CN node), example 800 relates to techniques that the CN node may use to identify the RAN node such that the appropriate application layer configuration can be retrieved.

For example, as shown by reference number 802, the information node may send, and the CN node may receive, information associated with one or more RAN nodes (e.g., RAN node 1, RAN node 2, and RAN node 3 in example 800). For example, as described herein, the information node may correspond to an OAM device, another CN node, an NTN gateway, a proxy node, a cloud server, a node that is co-located with the CN node, or any other suitable node with access to information associated with the RAN nodes. In some aspects, the information node may provide the information associated with the RAN nodes to the CN node at periodic intervals and/or in response to the CN node requesting the information associated with the RAN nodes.

In some aspects, as described herein, the information associated with the RAN nodes may generally indicate and/or may enable the CN node to determine an expected availability and/or an expected unavailability of each RAN node and/or a network interface between each RAN node and the CN node. For example, in an NTN architecture where the RAN nodes are provided on-board respective satellites, the information that the CN node receives from the information node may include satellite information, such as ephemeris information and/or information related to when the satellites and the on-board RAN nodes are expected to be available or unavailable. For example, the expected availability and/or the expected unavailability may be indicated according to absolute times or relative times from a reference time, according to location information (e.g., absolute locations, such as latitudes, longitudes, and/or altitudes), and/or relative distances from a reference point. Furthermore, in some aspects, the information associated with the RAN nodes may include identity information associated with the RAN nodes, such as satellite identifiers, RAN node identifiers, feeder link identifiers, TA identifiers, PLMN identifiers, and/or cell identifiers, among other examples. Additionally, or alternatively, the expected availability and/or the expected unavailability of the RAN node or the network interface associated with the RAN node may be indicated according to one or more state parameters (e.g., activated or deactivated, resumed or suspended, or the like).

In this way, the information that the CN node receives from the information node may indicate or may enable the CN node to determine when each RAN node or the network interface associated with each RAN node is expected to be available (e.g., due to a satellite associated with a RAN node being within or re-entering the service area associated with an NTN gateway or other terrestrial node that facilitates communication between the RAN node and the CN node). For example, in FIG. 8, the first RAN node is within the service area of the NTN gateway and the second and third RAN nodes are outside the service area of the NTN gateway when the CN node receives the RAN node information from the information node. Accordingly, as shown by reference number 804, the CN node may determine that the first RAN node is available at that time, and may use an identity associated with the first RAN node to obtain the appropriate application layer configuration for communicating over a network interface with the first RAN node.

As further shown by reference number 808, the CN node may determine that the first RAN node is transitioning to an unavailable state (e.g., due to a satellite associated with the first RAN node moving outside the service area of the NTN gateway) and that the second RAN node is transitioning to an available state (e.g., due to a satellite associated with the second RAN node re-entering the service area of the NTN gateway). Accordingly, the CN node may use an identity associated with the second RAN node to obtain the appropriate application layer configuration for communicating over a network interface with the second RAN node while the second RAN node or network interface associated with the second RAN node is available.

Similarly, as shown by reference number 810, the CN node may determine that the second RAN node is transitioning to an unavailable state (e.g., due to a satellite associated with the second RAN node moving outside the service area of the NTN gateway) and that the third RAN node is transitioning to an available state (e.g., due to a satellite associated with the third RAN node re-entering the service area of the NTN gateway). Accordingly, the CN node may use an identity associated with the third RAN node to obtain the appropriate application layer configuration for communicating over a network interface with the third RAN node while the third RAN node or network interface associated with the third RAN node is available.

As indicated above, FIG. 8 is provided as an example. Other examples may differ from what is described with regard to FIG. 8.

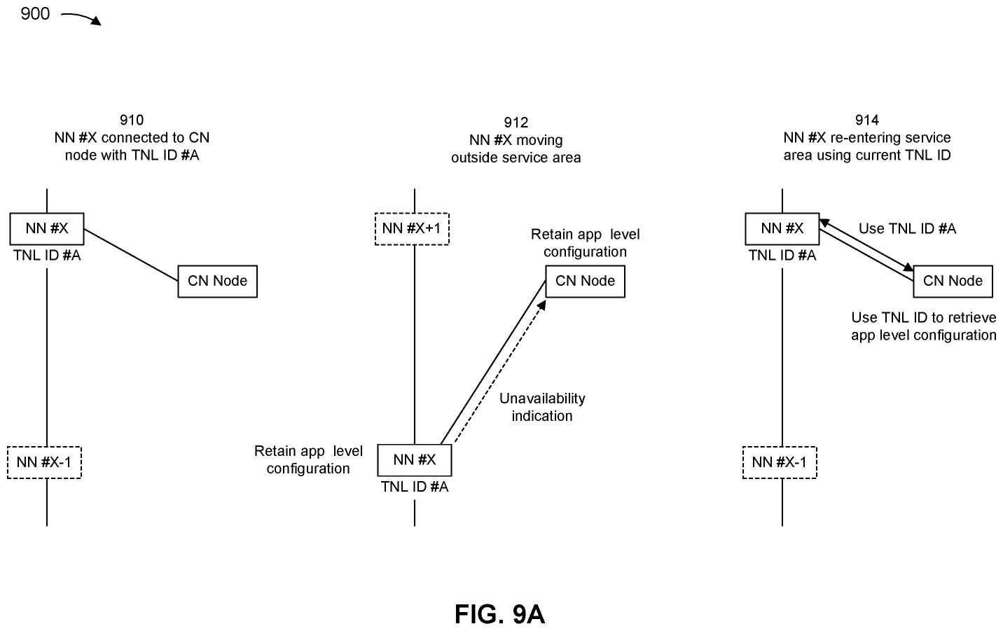

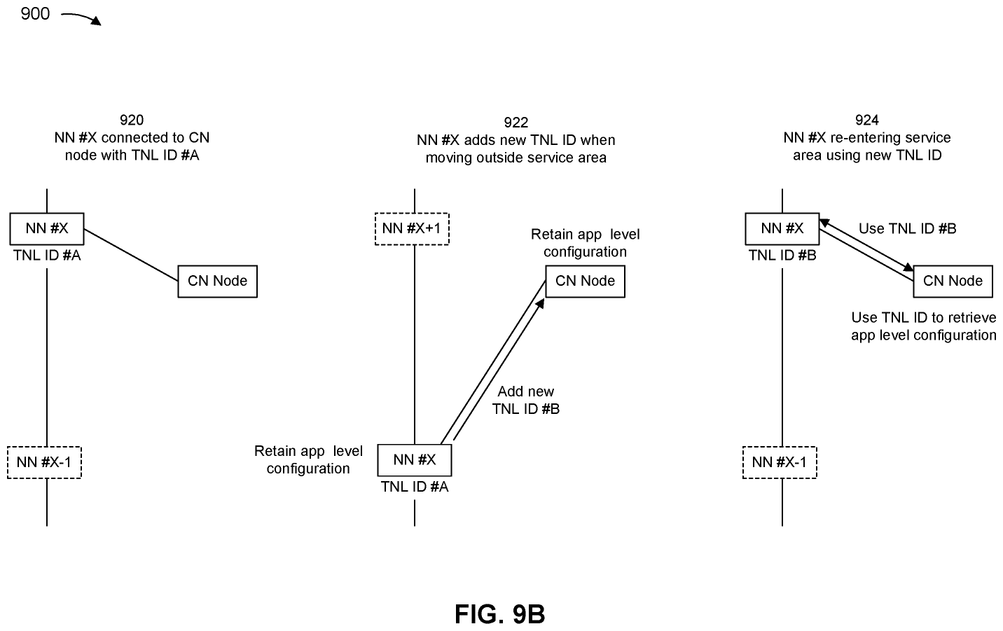

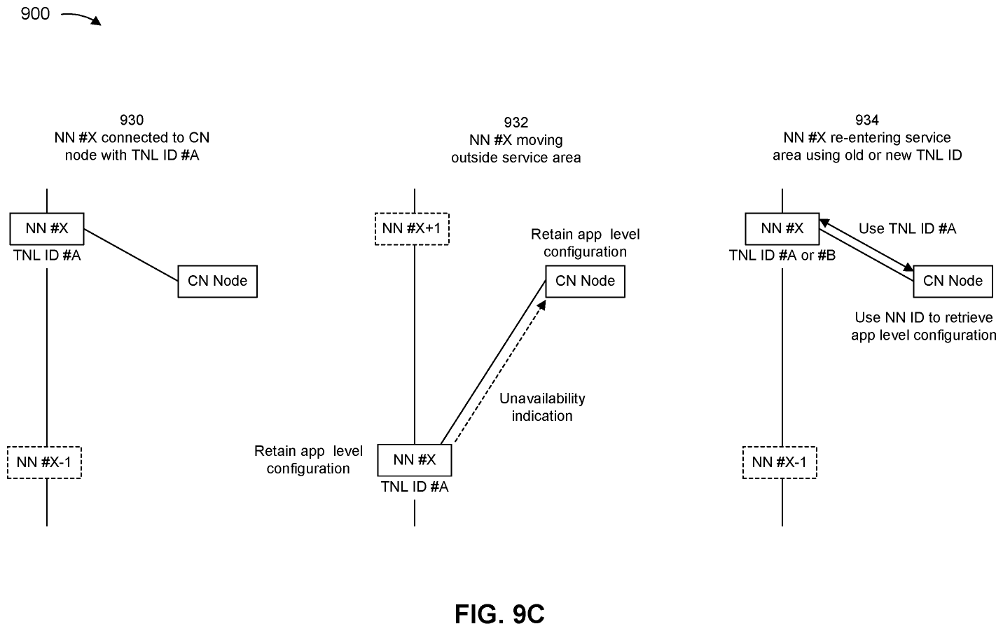

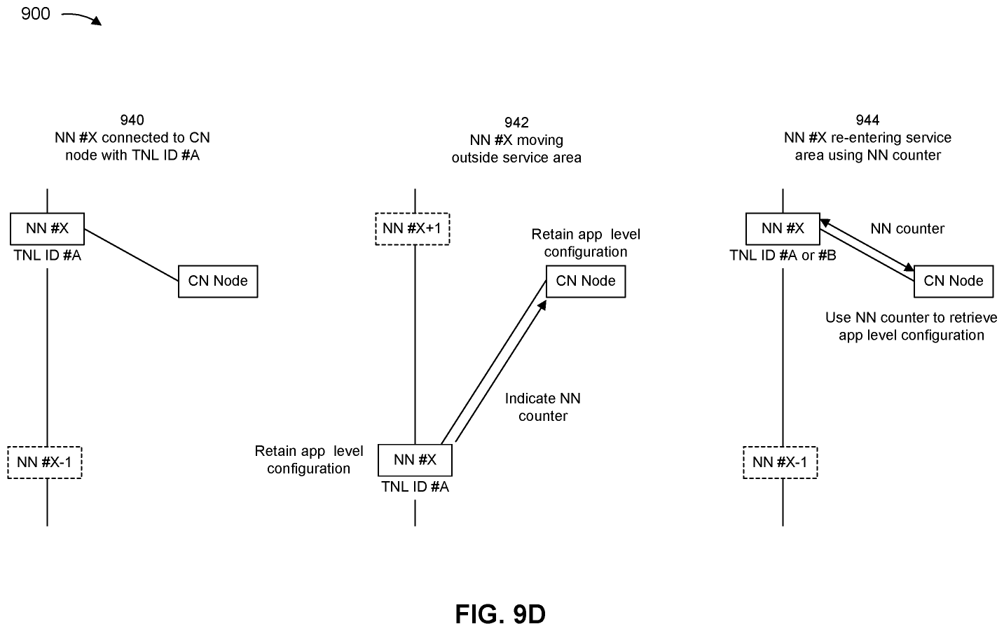

FIGS. 9A-9D are diagrams illustrating examples 900 associated with a CN node identifying a RAN node associated with an availability status that changes over time in accordance with one or more identities associated with the RAN node, in accordance with the present disclosure. As shown in FIGS. 9A-9D, examples 900 include communication between a CN node, such as an AMF, and one or more RAN nodes, such as a DU or a CU. In some aspects, the RAN nodes may each communicate with the CN node via an NG interface. Furthermore, in some aspects, the RAN nodes may be deployed on satellites in an NTN architecture. Accordingly, in some aspects, a terrestrial NTN gateway (not explicitly shown in FIGS. 9A-9D) may relay communications between the RAN nodes and the CN node. Although examples 900 may be described in a context related to communication between satellite-based RAN nodes and an AMF in an NTN architecture, the techniques described herein may be applied to any suitable network nodes and/or network interfaces with scheduled, configured, predictable, or otherwise expected transitions between available and unavailable states.

In some aspects, as described herein, the CN node may store a network interface (e.g., NG) application layer configuration for each RAN node that is expected to transition between available and unavailable states, and vice versa. Accordingly, when the RAN node or the network interface associated with the RAN node transitions from the unavailable state back to the available state (e.g., after the satellite associated with the RAN node has traveled around the Earth and re-enters the service area of an NTN gateway in communication with the CN node), examples 900 relates to techniques that the CN node may use to identify the RAN node such that the appropriate application layer configuration can be retrieved.

For example, as shown in FIG. 9A, the CN node may use a TNL identifier associated with a RAN node to identify the RAN node and retrieve the appropriate application layer configuration for communicating with the RAN node over a network interface when the RAN node or the network interface associated with the RAN node transitions from an unavailable state to an available state. For example, as shown by reference number 910, the CN node may be connected to a RAN node (e.g., RAN node #X) associated with a TNL identifier (e.g., TNL ID #A) while the RAN node and network interface associated with the RAN node is in an available state. For example, in some aspects, the TNL identifier may be an Internet Protocol (IP) address, a port identifier, or another suitable identifier. As further shown by reference number 912, when the RAN node or network interface associated with the RAN node is transitioning to an unavailable state (e.g., due to a satellite associated with the RAN node leaving the service area of an NTN gateway in communication with the CN node), the RAN node and the CN node may each retain an application layer configuration associated with the network interface between the RAN node and the CN node. Furthermore, in some aspects, the RAN node may optionally send an indication to the CN node prior to the RAN node or network interface associated with the RAN node transitioning to the unavailable state (e.g., as described above with reference to FIG. 6B and/or FIG. 6C). As further shown by reference number 914, when the RAN node or network interface associated with the RAN node is transitioning to the available state (e.g., due to the satellite associated with the RAN node re-entering the service area of the NTN gateway in communication with the CN node), the RAN node and the CN node may resume communication over the network interface using the stored application layer configuration. For example, as shown, the CN node may use the TNL identifier associated with the RAN node as a key to retrieve the application layer configuration used to communicate with the RAN node over the network interface.

Alternatively, as shown in FIG. 9B, the CN node may use a new TNL identifier associated with a RAN node to identify the RAN node when the RAN node or the network interface associated with the RAN node transitions from an unavailable state to an available state. For example, as shown by reference number 920, the CN node may be connected to a RAN node (e.g., RAN node #X) associated with a TNL identifier (e.g., TNL ID #A) while the RAN node and network interface associated with the RAN node is in an available state. As further shown by reference number 922, while the RAN node and network interface associated with the RAN node is in the available state, the RAN node may send, to the CN node, an indication to inform the CN node of a new TNL identifier to be used for subsequent communication when the RAN node or network interface associated with the RAN node transitions from an unavailable state back to the available state (e.g., in a RAN configuration update message or another suitable message). For example, in FIG. 9B, the new TNL identifier (e.g., TNL ID #B) is assigned when the RAN node is leaving the service area of the NTN gateway in communication with the CN node, although the new TNL identifier can be assigned at any suitable time when the RAN node or network interface associated with the RAN node transitions is in the available state. In some aspects, the RAN node may assign the new TNL identifier and an association for the new TNL identifier, and then indicate the new TNL identifier and the association for the new TNL identifier to the CN node (e.g., in a RAN configuration update message or another suitable message that includes an “NG-RAN TNL Association to add list” IE, an “NG-RAN TNL Association to add item” IE, a “TNL Association Transport Layer Address” IE, and/or a “TNL Association Transport Layer Address at AMF” IE). Additionally, or alternatively, the RAN node may assign the new TNL identifier and indicate the new TNL identifier to the CN node (e.g., in a RAN configuration update message or another suitable message that includes an “NG-RAN TNL Association to add list” IE, an “NG-RAN TNL Association to add item” IE, and/or a “TNL Association Transport Layer Address” IE), and the CN node may respond to the RAN node with an association for the new TNL identifier (e.g., in a RAN configuration update acknowledge message or another suitable message that includes an “NG-RAN TNL Association to add list” IE, an “NG-RAN TNL Association to add item” IE, a “TNL Association Transport Layer Address” IE, and/or a “TNL Association Transport Layer Address at AMF” IE).

As further shown by reference number 924, when the RAN node or network interface associated with the RAN node is transitioning to the available state (e.g., due to the satellite associated with the RAN node re-entering the service area of the NTN gateway in communication with the CN node), the RAN node and the CN node may resume communication over the network interface using the new TNL identifier. For example, as shown, the CN node may use the new TNL identifier associated with the RAN node as a key to retrieve the application layer configuration used to communicate with the RAN node over the network interface. Furthermore, in some aspects, the CN node may optionally update a configuration to remove the previous TNL identifier.

Alternatively, as shown in FIG. 9C, the CN node may use a global RAN node identifier or RAN node name to identify the RAN node when the RAN node or the network interface associated with the RAN node transitions from an unavailable state to an available state. For example, as shown by reference number 930, the CN node may be connected to the RAN node (e.g., RAN node #X) associated with a TNL identifier (e.g., TNL ID #A) while the RAN node and network interface associated with the RAN node is in an available state. As further shown by reference number 932, when the RAN node or network interface associated with the RAN node is transitioning to an unavailable state (e.g., due to a satellite associated with the RAN node leaving the service area of an NTN gateway in communication with the CN node), the RAN node and the CN node may each retain an application layer configuration associated with the network interface between the RAN node and the CN node. Furthermore, in some aspects, the RAN node may optionally send an indication to the CN node prior to the RAN node or network interface associated with the RAN node transitioning to the unavailable state (e.g., as described above with reference to FIG. 6B and/or FIG. 6C). As further shown by reference number 934, when the RAN node or network interface associated with the RAN node is transitioning to the available state (e.g., due to the satellite associated with the RAN node re-entering the service area of the NTN gateway in communication with the CN node), the RAN node and the CN node may resume communication over the network interface using the stored application layer configuration. For example, as shown, the CN node may use the global RAN node identifier or RAN node name associated with the RAN node as a key to retrieve the application layer configuration used to communicate with the RAN node over the network interface.

Alternatively, as shown in FIG. 9D, the CN node may use a key parameter, such as a counter, associated with a RAN node to identify the RAN node when the RAN node or the network interface associated with the RAN node transitions from an unavailable state to an available state. For example, as shown by reference number 940, the CN node may be connected to the RAN node (e.g., RAN node #X) associated with a TNL identifier (e.g., TNL ID #A) while the RAN node and network interface associated with the RAN node is in an available state. As further shown by reference number 942, while the RAN node and network interface associated with the RAN node is in the available state, a counter value may be assigned to the RAN node (e.g., by the RAN node or the CN node). In cases where the counter value is assigned by the RAN node, the RAN node may send, to the CN node, an indication of the counter value. Additionally, or alternatively, the RAN node and the CN node may increment the counter value when the RAN node or network interface associated with the RAN node changes state and/or when the RAN node disconnects from or reconnects to the CN node. Furthermore, in some aspects, the RAN node may inform the CN node of a new TNL identifier to be used for subsequent communication when the RAN node or network interface associated with the RAN node transitions from an unavailable state back to the available state (e.g., in a similar manner as described above with reference to FIG. 9B). Accordingly, as further shown by reference number 944, when the RAN node or network interface associated with the RAN node is transitioning to the available state (e.g., due to the satellite associated with the RAN node re-entering the service area of the NTN gateway in communication with the CN node), the RAN node and the CN node may resume communication over the network interface using the counter or other key parameter. For example, in some aspects, the RAN node may indicate the counter value to the CN node, which may use the counter value as a key to retrieve the application layer configuration used to communicate with the RAN node over the network interface. Furthermore, in some aspects, the CN node may optionally modify an association with the RAN node in cases where the TNL identifier associated with the RAN node has changed.

As indicated above, FIGS. 9A-9D are provided as examples. Other examples may differ from what is described with regard to FIGS. 9A-9D.

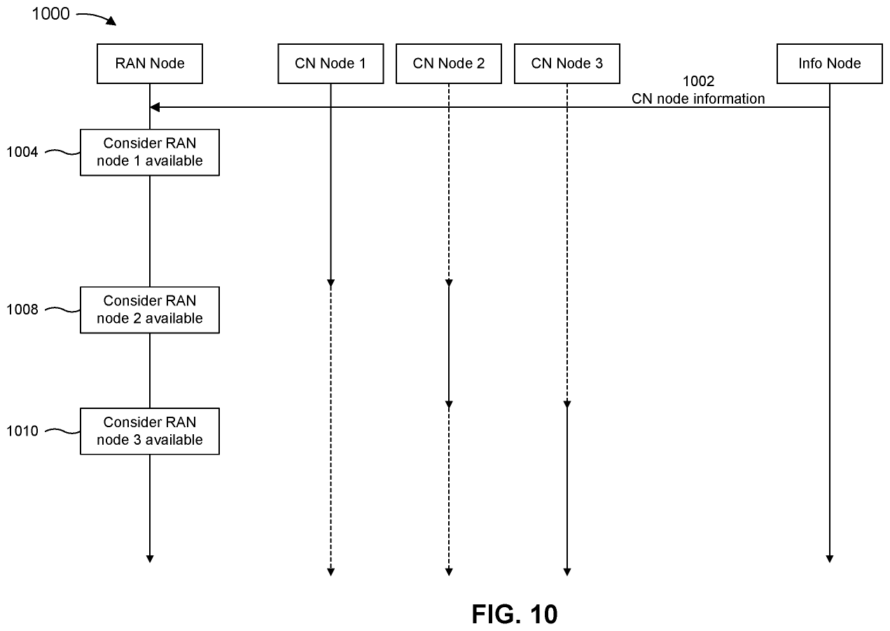

FIG. 10 is a diagram illustrating an example 1000 associated with configuring a RAN node with information to identify a CN node associated with an availability status that changes over time, in accordance with the present disclosure. As shown in FIG. 10, example 1000 includes communication between a RAN node, such as a DU or a CU, and one or more CN nodes, such as one or more AMFs. In some aspects, the CN nodes may each communicate with the RAN node via an NG interface. Furthermore, in some aspects, the RAN node may be deployed on a satellite in an NTN architecture. Accordingly, in some aspects, one or more terrestrial NTN gateways (not explicitly shown in FIG. 10) may relay communications between the RAN node and the CN nodes. Furthermore, as shown in FIG. 10, example 1000 includes communication between the RAN node and an information node. Although example 1000 may be described in a context related to communication between a satellite-based RAN node and AMFs in an NTN architecture, the techniques described herein may be applied to any suitable network nodes and/or network interfaces with scheduled, configured, predictable, or otherwise expected transitions between available and unavailable states.

In some aspects, as described herein, when the RAN node determines that the state associated with a CN node or a network interface associated with a CN node is expected to be an unavailable state (e.g., due to a satellite associated with the RAN node being outside a service area associated with an NTN gateway in communication with the CN node), the RAN node may maintain an application layer configuration associated with the CN node or the network interface associated with the CN node until the CN node transitions back to an available state (e.g., due to the satellite associated with the RAN node re-entering the service area associated with the NTN gateway in communication with that CN node). For example, in some aspects, the RAN node may observe several CN nodes (e.g., different AMFs) over the course of an orbit around the Earth due to satellite movement. Accordingly, as described herein, the RAN node may store a network interface (e.g., NG) application layer configuration for each CN node that is expected to transition from an available state to an unavailable state, and vice versa. Accordingly, when the CN node or the network interface associated with the CN node transitions from the unavailable state back to the available state (e.g., after the satellite associated with the RAN node has traveled around the Earth and re-enters the service area of an NTN gateway in communication with the CN node), example 1000 relates to techniques that the RAN node may use to identify the CN node such that the appropriate application layer configuration can be retrieved.

For example, as shown by reference number 1002, the information node may send, and the RAN node may receive, information associated with one or more CN nodes (e.g., shown as CN node 1, CN node 2, and CN node 3 in example 1000). For example, as described herein, the information node may correspond to an OAM device, another CN node, an NTN gateway, a cloud server, a node that is co-located with the CN node, or any other suitable node with access to information associated with the CN nodes. In some aspects, the information node may provide the information associated with the CN nodes to the RAN node at periodic intervals and/or in response to the RAN node requesting the information associated with the CN nodes.

In some aspects, as described herein, the information associated with the CN nodes may generally indicate and/or may enable the RAN node to determine an expected availability and/or an expected unavailability of each CN node and/or a network interface between each CN node and the RAN node. For example, in an NTN architecture where the RAN node is provided on-board a satellite, the information that the RAN node receives from the information node may include information related to when the various CN nodes are expected to be available or unavailable. For example, the expected availability and/or the expected unavailability may be indicated according to absolute times or relative times from a reference time, according to location information (e.g., absolute locations of the CN nodes, such as latitudes and/or longitudes), and/or relative distances from a reference point. Furthermore, in some aspects, the information associated with the CN nodes may include identity information associated with the CN nodes. Additionally, or alternatively, the expected availability and/or the expected unavailability of the CN nodes or the network interfaces associated with the CN nodes may be indicated according to one or more state parameters (e.g., activated or deactivated, resumed or suspended, or the like).

In this way, the information that the RAN node receives from the information node may indicate or may enable the RAN node to determine when each CN node or network interface associated with each CN node is expected to be available (e.g., due to a satellite associated with the RAN node being within or re-entering the service area associated with an NTN gateway or other terrestrial node that facilitates communication between the RAN node and the CN node). For example, in FIG. 10, the RAN node is within the service area of an NTN gateway in communication with the first CN node and is outside the service areas of NTN gateways in communication with the second and third CN nodes when the RAN node receives the CN node information from the information node. Accordingly, as shown by reference number 1004, the RAN node may determine that the first CN node is available at that time, and may use an identity associated with the first CN node to obtain the appropriate application layer configuration for communicating over a network interface with the first CN node.

As further shown by reference number 1008, the RAN node may determine that the first CN node is transitioning to an unavailable state (e.g., due to a satellite associated with the RAN node moving outside the service area of the NTN gateway in communication with the first CN node) and that the second CN node is transitioning to an available state (e.g., due to the satellite associated with the RAN node re-entering the service area of an NTN gateway in communication with the second CN node).

Accordingly, the RAN node may use an identity associated with the second CN node to obtain the appropriate application layer configuration for communicating over a network interface with the second CN node while the second CN node or network interface associated with the second CN node is available.

Similarly, as shown by reference number 1010, the RAN node may determine that the second CN node is transitioning to an unavailable state (e.g., due to the satellite associated with the RAN node moving outside the service area of the NTN gateway in communication with the second CN node) and that the third CN node is transitioning to an available state (e.g., due to the satellite associated with the RAN node re-entering the service area of the NTN gateway in communication with the third CN node).

Accordingly, the RAN node may use an identity associated with the third CN node to obtain the appropriate application layer configuration for communicating over a network interface with the third CN node while the third CN node or network interface associated with the third CN node is available.

As indicated above, FIG. 10 is provided as an example. Other examples may differ from what is described with regard to FIG. 10.

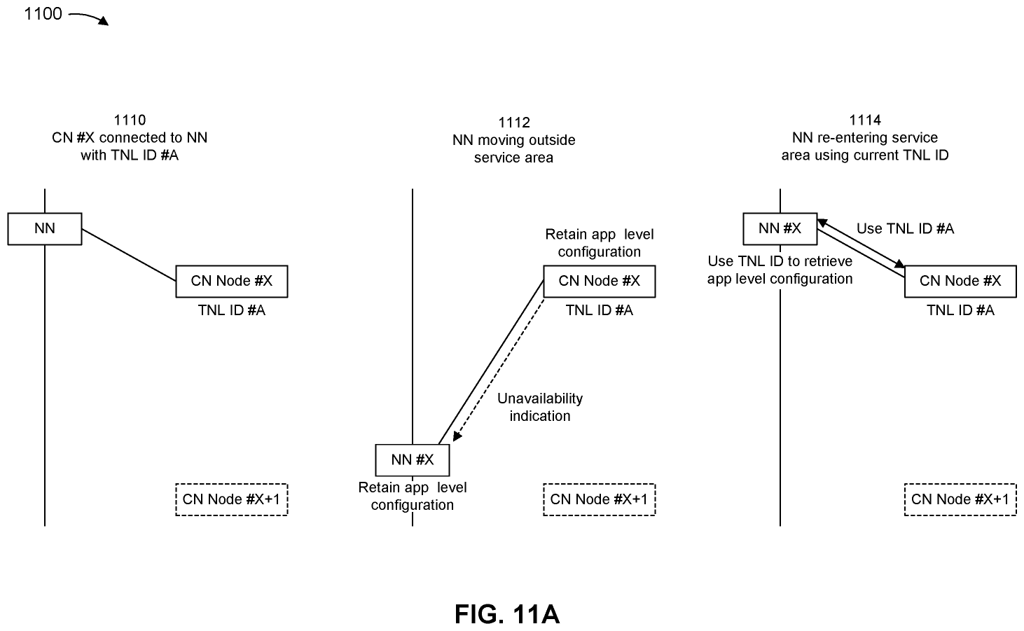

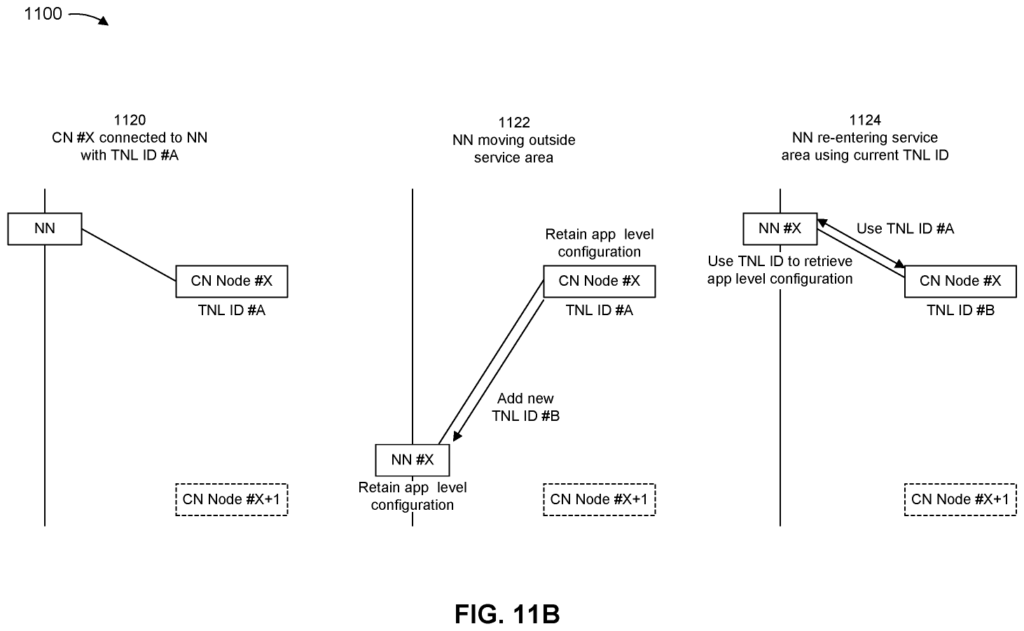

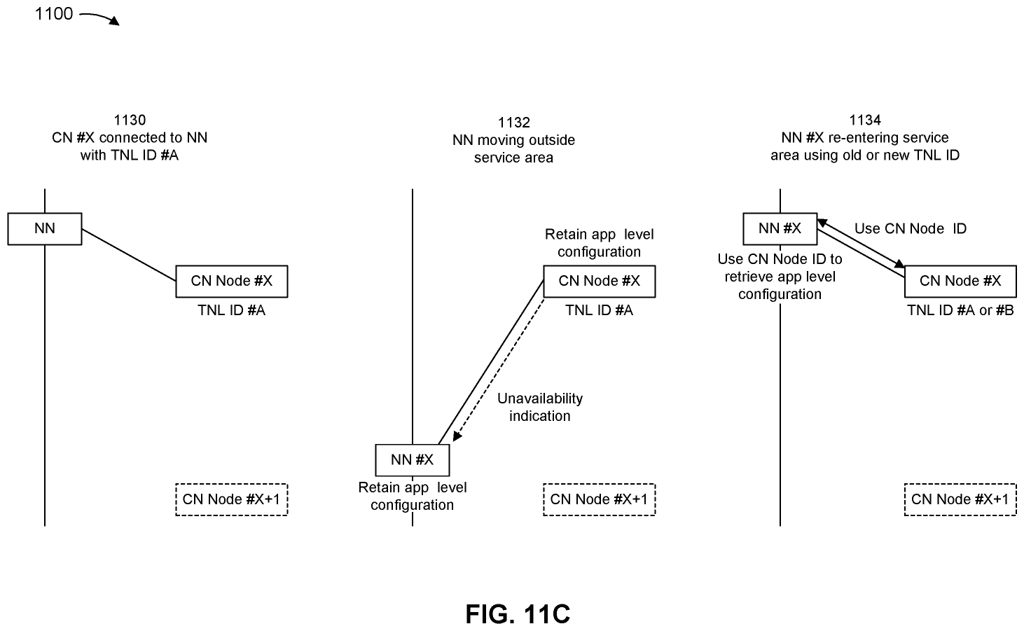

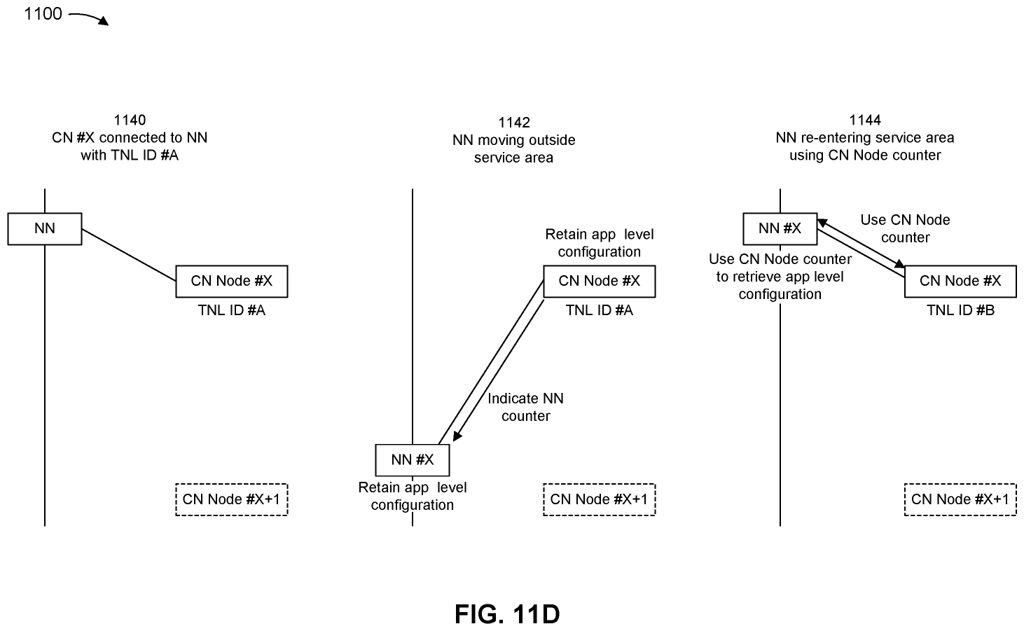

FIGS. 11A-11D are diagrams illustrating examples 1100 associated with a RAN network node identifying a CN node associated with an availability status that changes over time in accordance with one or more identities associated with the CN node, in accordance with the present disclosure. As shown in FIGS. 11A-11D, examples 1100 include communication between one or more CN nodes, such as one or more AMFs, and a RAN node, such as a DU or a CU. In some aspects, the RAN node may communicate with the CN nodes via respective NG interface. Furthermore, in some aspects, the RAN node may be deployed on a satellite in an NTN architecture. Accordingly, in some aspects, a terrestrial NTN gateway (not explicitly shown in FIGS. 11A-11D) may relay communications between the RAN node and the CN nodes.

Although examples 1100 may be described in a context related to communication between a satellite-based RAN node and AMFs in an NTN architecture, the techniques described herein may be applied to any suitable network nodes and/or network interfaces with scheduled, configured, predictable, or otherwise expected transitions between available and unavailable states.

In some aspects, as described herein, the RAN node may store a network interface (e.g., NG) application layer configuration for each CN node that is expected to transition between available and unavailable states, and vice versa. Accordingly, when a CN node or network interface associated with a CN node transitions from the unavailable state back to the available state (e.g., after the satellite associated with the RAN node has traveled around the Earth and re-enters the service area of an NTN gateway in communication with the CN node), examples 1100 relates to techniques that the RAN node may use to identify the CN node such that the appropriate application layer configuration can be retrieved.

For example, as shown in FIG. 11A, the RAN node may use a TNL identifier associated with a CN node to identify the CN node and retrieve the appropriate application layer configuration for communicating with the CN node over a network interface when the CN node or the network interface associated with the CN node transitions from an unavailable state to an available state. For example, as shown by reference number 1110, the RAN node may be connected to a CN node (e.g., CN node #X) associated with a TNL identifier (e.g., TNL ID #A) while the CN node and network interface associated with the CN node is in an available state. For example, in some aspects, the TNL identifier may be an IP address, a port identifier, or another suitable identifier. As further shown by reference number 1112, when the CN node or network interface associated with the CN node is transitioning to an unavailable state (e.g., due to a satellite associated with the RAN node leaving the service area of an NTN gateway in communication with the CN node), the RAN node and the CN node may each retain an application layer configuration associated with the network interface between the RAN node and the CN node. Furthermore, in some aspects, the CN node may optionally send an indication to the RAN node prior to the CN node or network interface associated with the CN node transitioning to the unavailable state (e.g., as described above with reference to FIG. 7B and/or FIG. 7C). As further shown by reference number 1114, when the CN node or network interface associated with the CN node is transitioning to the available state (e.g., due to the satellite associated with the RAN node re-entering the service area of the NTN gateway in communication with the CN node), the RAN node and the CN node may resume communication over the network interface using the stored application layer configuration. For example, as shown, the RAN node may use the TNL identifier associated with the CN node as a key to retrieve the application layer configuration used to communicate with the CN node over the network interface.

Alternatively, as shown in FIG. 11B, the RAN node may use a new TNL identifier associated with a CN node to identify the CN node when the CN node or the network interface associated with the CN node transitions from an unavailable state to an available state. For example, as shown by reference number 1120, the RAN node may be connected to a CN node (e.g., CN node #X) associated with a TNL identifier (e.g., TNL ID #A) while the CN node and network interface associated with the CN node is in an available state. As further shown by reference number 1122, while the CN node and network interface associated with the CN node is in the available state, the CN node may send, to the RAN node, an indication to inform the RAN node of a new TNL identifier to be used for subsequent communication when the CN node or network interface associated with the CN node transitions from an unavailable state back to the available state (e.g., in a RAN configuration update message or another suitable message). For example, in FIG. 11B, the new TNL identifier (e.g., TNL ID #B) is assigned when the RAN node is leaving the service area of the NTN gateway in communication with the CN node, although the new TNL identifier can be assigned at any suitable time when the CN node or network interface associated with the CN node transitions is in the available state. As further shown by reference number 1124, when the CN node or network interface associated with the CN node is transitioning to the available state (e.g., due to the satellite associated with the RAN node re-entering the service area of the NTN gateway in communication with the CN node), the CN node and the RAN node may resume communication over the network interface using the new TNL identifier. For example, as shown, the RAN node may use the new TNL identifier associated with the CN node as a key to retrieve the application layer configuration used to communicate with the CN node over the network interface. Furthermore, in some aspects, the RAN node may optionally update a configuration to remove the previous TNL identifier.

Alternatively, as shown in FIG. 11C, the RAN node may use a GUAMI or a CN node name to identify the CN node when the CN node or the network interface associated with the CN node transitions from an unavailable state to an available state. For example, as shown by reference number 1130, the RAN node may be connected to the CN node (e.g., CN node #X) associated with a TNL identifier (e.g., TNL ID #A) while the CN node and network interface associated with the CN node is in an available state. As further shown by reference number 1132, when the CN node or network interface associated with the CN node is transitioning to an unavailable state (e.g., due to a satellite associated with the RAN node leaving the service area of an NTN gateway in communication with the CN node), the CN node and the RAN node may each retain an application layer configuration associated with the network interface between the CN node and the RAN node. Furthermore, in some aspects, the CN node may optionally send an indication to the RAN node prior to the CN node or network interface associated with the CN node transitioning to the unavailable state (e.g., as described above with reference to FIG. 7B and/or FIG. 7C). As further shown by reference number 1134, when the CN node or network interface associated with the CN node is transitioning to the available state (e.g., due to the satellite associated with the RAN node re-entering the service area of the NTN gateway in communication with the CN node), the RAN node and the CN node may resume communication over the network interface using the stored application layer configuration. For example, as shown, the RAN node may use the GUAMI or CN node name associated with the CN node as a key to retrieve the application layer configuration used to communicate with the CN node over the network interface.

Alternatively, as shown in FIG. 11D, the RAN node may use a key parameter, such as a counter, associated with a CN node to identify the CN node when the CN node or the network interface associated with the CN node transitions from an unavailable state to an available state. For example, as shown by reference number 1140, the RAN node may be connected to the CN node (e.g., CN node #X) associated with a TNL identifier (e.g., TNL ID #A) while the CN node and network interface associated with the CN node is in an available state. As further shown by reference number 1142, while the CN node and network interface associated with the CN node is in the available state, a counter value may be assigned to the CN node (e.g., by the RAN node or the CN node). In cases where the counter value is assigned by the CN node, the CN node may send, to the RAN ode, an indication of the counter value. Additionally, or alternatively, the RAN node and the CN node may increment the counter value when the CN node or network interface associated with the CN node changes state and/or when the RAN node disconnects from or reconnects to the CN node. Furthermore, in some aspects, the CN node may inform the RAN node of a new TNL identifier to be used for subsequent communication when the CN node or network interface associated with the CN node transitions from an unavailable state back to the available state (e.g., in a similar manner as described above with reference to FIG. 11B). Accordingly, as further shown by reference number 1144, when the CN node or network interface associated with the CN node is transitioning to the available state (e.g., due to the satellite associated with the RAN node re-entering the service area of the NTN gateway in communication with the CN node), the RAN node and the CN node may resume communication over the network interface using the counter or other key parameter. For example, in some aspects, the CN node may indicate the counter value to the RAN node, which may use the counter value as a key to retrieve the application layer configuration used to communicate with the CN node over the network interface. Furthermore, in some aspects, the CN node may optionally modify an association with the CN node in cases where the TNL identifier associated with the CN node has changed.

As indicated above, FIGS. 11A-11D are provided as examples. Other examples may differ from what is described with regard to FIGS. 11A-11D.

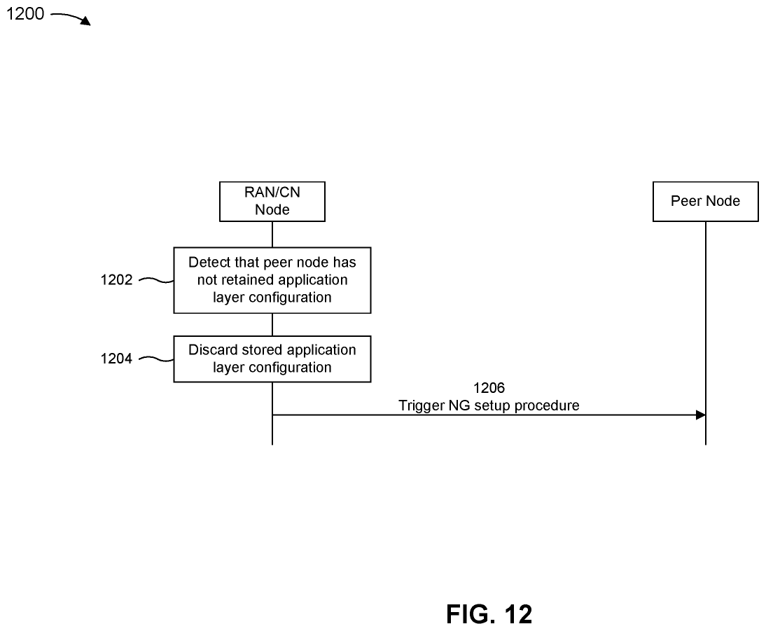

FIG. 12 is a diagram illustrating an example 1200 associated with recovering from an error state in which a peer network node does not retain an application layer configuration for a network interface after one or more changes to an availability status of the peer network node, in accordance with the present disclosure. As shown in FIG. 12, example 1200 includes communication between a first network node and a peer network node. For example, in some aspects, the first network node may be a RAN node and the peer network node may be a CN node. Additionally, or alternatively, the first network node may be a CN node and the peer network node may be a RAN node. In some aspects, the first network node may communicate with the peer network node via an NG interface. Furthermore, in some aspects, either the first network node or the peer network node may be a RAN node deployed on a satellite in an NTN architecture. Accordingly, in some aspects, a terrestrial NTN gateway (not explicitly shown in FIG. 12) may relay communications between the first network node and the peer network node. Although example 1200 may be described in a context related to communication between a satellite-based RAN node and a CN node in an NTN architecture, the techniques described herein may be applied to any suitable network nodes and/or network interfaces with scheduled, configured, predictable, or otherwise expected transitions between available and unavailable states.

In some aspects, as described herein, a RAN node and a CN node may generally maintain respective application layer configurations associated with a network interface used for communication between the RAN node and the CN node while the other node is expected to be in an unavailable state. However, in some cases, the RAN node and/or the CN node may be unable to retain the application layer configuration (e.g., due to an internal memory error). In such cases, the RAN node and the CN node may need to perform an NG setup procedure to re-establish the respective application layer configurations. Accordingly, example 1200 relates to techniques to ensure that each network node is aware of the need to re-establish the respective application layer configurations to avoid one or more retries (e.g., where an AMF or RAN configuration update message is sent multiple times in an error or abnormal case).

For example, as shown by reference number 1202, the first network node may detect that the peer network node has not retained an application layer configuration for a network interface between the first network node and the peer network node. For example, in some aspects, the first network node may detect that the peer network node has not retained the application layer configuration for the network interface in accordance with a failure count satisfying (e.g., exceeding) a threshold and/or a period from a procedure start satisfying (e.g., exceeding) a threshold. Additionally, or alternatively, the first network node may detect that the peer network node has not retained the application layer configuration for the network interface in accordance with an indication from the peer network node. For example, when a RAN node sends a RAN configuration update message to an AMF and the AMF is unable to accept the RAN configuration update, the AMF generally responds to the RAN configuration update message with a RAN configuration update failure message that includes an appropriate cause value. Accordingly, in some aspects, the first network node may detect that the peer network node has not retained the application layer configuration for the network interface in accordance with a message received from the peer network node including an indication such as an “unknown node” cause value. In some aspects, the indication may be associated with a time to wait parameter set to a specific value, such as 0 or infinity. For example, when a CN node sends an indication or failure cause value to a RAN node with a time to wait parameter, the RAN node generally waits at least the indicated time before reinitiating the RAN configuration update procedure toward the same CN node. Accordingly, the time to wait parameter may be set to the specific value to indicate the need to re-establish the application layer configurations and prevent the first network node from reinitiating the RAN configuration update procedure.

Accordingly, as shown by reference number 1204, the first network node may discard a stored application layer configuration for the network interface used to communicate with the peer network node responsive to detecting that the peer network node has not retained the application layer configuration for the network interface. As further shown by reference number 1206, the first network node may then trigger a procedure to establish the application layer configurations for the network interface. For example, in some aspects, the first network node may trigger an NG setup procedure in a similar manner as described above with reference to FIG. 5. Additionally, or alternatively, the first network node may report, to the peer network node or another suitable node, that a communication or procedure using the stored application layer configuration failed. In such cases, the report may indicate an identity associated with the first network node and/or the peer network node.

As indicated above, FIG. 12 is provided as an example. Other examples may differ from what is described with regard to FIG. 12.

FIG. 13 is a diagram illustrating an example process 1300 performed, for example, at a first network node or an apparatus of a first network node, in accordance with the present disclosure. Example process 1300 is an example where the apparatus or the first network node (e.g., a RAN node, such as a CU or a DU, or a CN node, such as an AMF) performs operations associated with a network interface unavailability configuration.

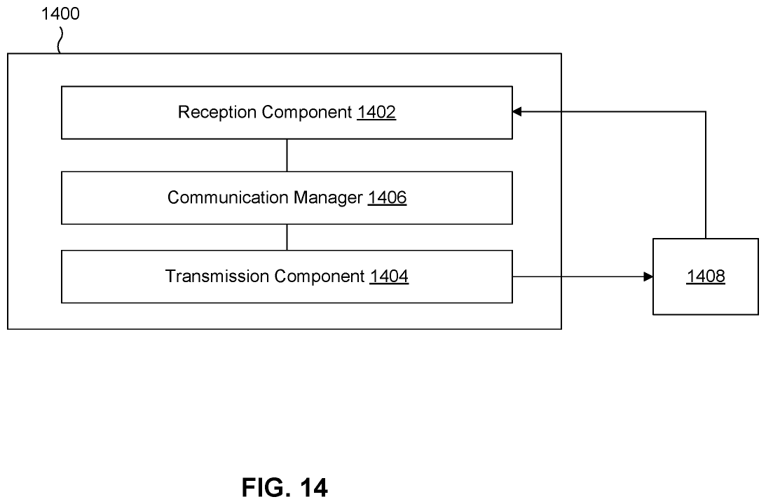

As shown in FIG. 13, in some aspects, process 1300 may include receiving information that indicates an expected unavailability of a second network node or a network interface between the first network node and the second network node (block 1310). For example, the first network node (e.g., using reception component 1402 and/or communication manager 1406, depicted in FIG. 14) may receive information that indicates an expected unavailability of a second network node or a network interface between the first network node and the second network node, as described above.

As further shown in FIG. 13, in some aspects, process 1300 may include determining, in accordance with the received information, that a state of the second network node or the network interface between the first network node and the second network node is an unavailable state (block 1320). For example, the first network node (e.g., using communication manager 1406, depicted in FIG. 14) may determine, in accordance with the received information, that a state of the second network node or the network interface between the first network node and the second network node is an unavailable state, as described above.

As further shown in FIG. 13, in some aspects, process 1300 may include maintaining an application layer configuration associated with the second network node or the network interface while the state of the second network node or the network interface is the unavailable state (block 1330). For example, the first network node (e.g., using communication manager 1406, depicted in FIG. 14) may maintain an application layer configuration associated with the second network node or the network interface while the state of the second network node or the network interface is the unavailable state, as described above.

Process 1300 may include additional aspects, such as any single aspect or any combination of aspects described below and/or in connection with one or more other processes described elsewhere herein.

In a first aspect, the received information indicates a change to the expected unavailability of the second network node or the network interface over time in accordance with a movement of a satellite associated with the first network node or the second network node.

In a second aspect, alone or in combination with the first aspect, the information that indicates the expected unavailability of the second network or the network interface is received from an information node periodically or in response to a request from the first network node.

In a third aspect, alone or in combination with one or more of the first and second aspects, process 1300 includes transmitting, to the second network node, a message indicating the state of the second network node or the network interface between the first network node and the second network node.

In a fourth aspect, alone or in combination with one or more of the first through third aspects, process 1300 includes prohibiting one or more procedures while the state of the second network node or the network interface between the first network node and the second network node is the unavailable state.

In a fifth aspect, alone or in combination with one or more of the first through fourth aspects, process 1300 includes triggering one or more procedures related to managing the network interface between the first network node and the second network node while the state of the second network node or the network interface between the first network node and the second network node is the unavailable state.

In a sixth aspect, alone or in combination with one or more of the first through fifth aspects, the received information indicates the state of the second network node or the network interface and a duration associated with the state, a location associated with the state, or a time of a next change to the state.

In a seventh aspect, alone or in combination with one or more of the first through sixth aspects, the information that indicates the expected unavailability of the second network node or the network interface is associated with a trigger related to one or more of a movement of a satellite associated with the first network node or the second network node, a configured timing, a location associated with a satellite, or a periodic timer expiring.

In an eighth aspect, alone or in combination with one or more of the first through seventh aspects, process 1300 includes transmitting, to the second network node, a message that includes a request to change the state of the second network node or the network interface between the first network node and the second network node, wherein the information that indicates the expected unavailability of the second network node or the network interface is responsive to the request.

In a ninth aspect, alone or in combination with one or more of the first through eighth aspects, process 1300 includes transmitting, to the second network node, a request to change the state of the second network node or the network interface between the first network node and the second network node, wherein the request is transmitted in response to receiving the information that indicates the expected unavailability of the second network node or the network interface.

In a tenth aspect, alone or in combination with one or more of the first through ninth aspects, the information that indicates the expected unavailability of the second network node or the network interface between the first network node and the second network node is associated with a setup message for the network interface or a configuration update message.

In an eleventh aspect, alone or in combination with one or more of the first through tenth aspects, process 1300 includes determining, in accordance with the received information, that the state of the network interface has changed from the unavailable state to an available state, and communicating with the second network node over the network interface in accordance with the application layer configuration responsive to the state of the second network node or the network interface changing to the available state.

In a twelfth aspect, alone or in combination with one or more of the first through eleventh aspects, communication with the second network node over the network interface is associated with a TNL identifier associated with the second network node.

In a thirteenth aspect, alone or in combination with one or more of the first through twelfth aspects, the TNL identifier associated with the second network node is a TNL identifier that is assigned to the second network node in a configuration update.

In a fourteenth aspect, alone or in combination with one or more of the first through thirteenth aspects, communication with the second network node over the network interface is associated with an identifier or a name associated with the second network node.

In a fifteenth aspect, alone or in combination with one or more of the first through fourteenth aspects, communication with the second network node over the network interface is associated with a key parameter associated with the second network node.

In a sixteenth aspect, alone or in combination with one or more of the first through fifteenth aspects, process 1300 includes detecting that the application layer configuration is not available in the second network node, and triggering a setup procedure to establish the application layer configuration associated with the network interface responsive to detecting that the application layer configuration is not available in the second network node.

In a seventeenth aspect, alone or in combination with one or more of the first through sixteenth aspects, detecting that the application layer configuration is not available in the second network node is in accordance with one or more of a failure count associated with a configuration update procedure, expiration of a time period from a start of the configuration update procedure, or an indication included in a failure message associated with the configuration update procedure.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a first network node, or a first network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6A-6C, FIGS. 7A-7C, FIG. 8, FIGS. 9A-9D, FIG. 10, and/or FIGS. 11A-11D. Additionally, or alternatively, the apparatus 1400 may be configured to perform one or more processes described herein, such as process 1300 of FIG. 13. In some aspects, the apparatus 1400 and/or one or more components shown in FIG. 14 may include one or more components of the first network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the first network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the first network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive information that indicates an expected unavailability of a network node or a network interface between the apparatus 1400 and the network node. The communication manager 1406 may determine, in accordance with the received information, that a state of the network node or the network interface between the apparatus 1400 and the network node is an unavailable state. The communication manager 1406 may maintain an application layer configuration associated with the network node or the network interface while the state of the network node or the network interface is the unavailable state.

The transmission component 1404 may transmit, to the network node, a message indicating the state of the network node or the network interface between the apparatus 1400 and the network node.

The communication manager 1406 may prohibit one or more procedures while the state of the network node or the network interface between the apparatus 1400 and the network node is the unavailable state.

The communication manager 1406 may trigger one or more procedures related to managing the network interface between the apparatus 1400 and the network node while the state of the network node or the network interface between the apparatus 1400 and the network node is the unavailable state.

The transmission component 1404 may transmit, to the network node, a message that includes a request to change the state of the network node or the network interface between the apparatus 1400 and the network node, wherein the information that indicates the expected unavailability of the network node or the network interface is responsive to the request.

The transmission component 1404 may transmit, to the network node, a request to change the state of the network node or the network interface between the apparatus 1400 and the network node, wherein the request is transmitted in response to receiving the information that indicates the expected unavailability of the network node or the network interface.

The communication manager 1406 may determine, in accordance with the received information, that the state of the network interface has changed from the unavailable state to an available state. The communication manager 1406 may communicate with the network node over the network interface in accordance with the application layer configuration responsive to the state of the network node or the network interface changing to the available state.

The communication manager 1406 may detect that the application layer configuration is not available in the network node. The communication manager 1406 may trigger a setup procedure to establish the application layer configuration associated with the network interface responsive to detecting that the application layer configuration is not available in the network node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a first network node, comprising: receiving information that indicates an expected unavailability of a second network node or a network interface between the first network node and the second network node; determining, in accordance with the received information, that a state of the second network node or the network interface between the first network node and the second network node is an unavailable state; and maintaining an application layer configuration associated with the second network node or the network interface while the state of the second network node or the network interface is the unavailable state.

Aspect 2: The method of Aspect 1, wherein the received information indicates a change to the expected unavailability of the second network node or the network interface over time in accordance with a movement of a satellite associated with the first network node or the second network node.

Aspect 3: The method of any of Aspects 1-2, wherein the information that indicates the expected unavailability of the second network or the network interface is received from an information node periodically or in response to a request from the first network node.

Aspect 4: The method of any of Aspects 1-3, further comprising: transmitting, to the second network node, a message indicating the state of the second network node or the network interface between the first network node and the second network node.

Aspect 5: The method of any of Aspects 1-4, further comprising: prohibiting one or more procedures while the state of the second network node or the network interface between the first network node and the second network node is the unavailable state.

Aspect 6: The method of any of Aspects 1-5, further comprising: triggering one or more procedures related to managing the network interface between the first network node and the second network node while the state of the second network node or the network interface between the first network node and the second network node is the unavailable state.

Aspect 7: The method of any of Aspects 1-6, wherein the received information indicates the state of the second network node or the network interface and a duration associated with the state, a location associated with the state, or a time of a next change to the state.

Aspect 8: The method of any of Aspects 1-7, wherein the information that indicates the expected unavailability of the second network node or the network interface is associated with a trigger related to one or more of a movement of a satellite associated with the first network node or the second network node, a configured timing, a location associated with a satellite, or a periodic timer expiring.

Aspect 9: The method of any of Aspects 1-8, further comprising: transmitting, to the second network node, a message that includes a request to change the state of the second network node or the network interface between the first network node and the second network node, wherein the information that indicates the expected unavailability of the second network node or the network interface is responsive to the request.

Aspect 10: The method of any of Aspects 1-9, further comprising: transmitting, to the second network node, a request to change the state of the second network node or the network interface between the first network node and the second network node, wherein the request is transmitted in response to receiving the information that indicates the expected unavailability of the second network node or the network interface.

Aspect 11: The method of any of Aspects 1-10, wherein the information that indicates the expected unavailability of the second network node or the network interface between the first network node and the second network node is associated with a setup message for the network interface or a configuration update message.

Aspect 12: The method of any of Aspects 1-11, further comprising: determining, in accordance with the received information, that the state of the network interface has changed from the unavailable state to an available state; and communicating with the second network node over the network interface in accordance with the application layer configuration responsive to the state of the second network node or the network interface changing to the available state.

Aspect 13: The method of Aspect 12, wherein communication with the second network node over the network interface is associated with a TNL identifier associated with the second network node.

Aspect 14: The method of Aspect 13, wherein the TNL identifier associated with the second network node is a TNL identifier that is assigned to the second network node in a configuration update.

Aspect 15: The method of Aspect 12, wherein communication with the second network node over the network interface is associated with an identifier or a name associated with the second network node.

Aspect 16: The method of Aspect 12, wherein communication with the second network node over the network interface is associated with a key parameter associated with the second network node.

Aspect 17: The method of any of Aspects 1-16, further comprising: detecting that the application layer configuration is not available in the second network node; and triggering a setup procedure to establish the application layer configuration associated with the network interface responsive to detecting that the application layer configuration is not available in the second network node.

Aspect 18: The method of Aspect 17, wherein detecting that the application layer configuration is not available in the second network node is in accordance with one or more of a failure count associated with a configuration update procedure, expiration of a time period from a start of the configuration update procedure, or an indication included in a failure message associated with the configuration update procedure.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A method of wireless communication performed by a first network node, comprising:
receiving information that indicates an expected unavailability of a second network node or a network interface between the first network node and the second network node;
determining, in accordance with the received information, that a state of the second network node or the network interface between the first network node and the second network node is an unavailable state; and
maintaining an application layer configuration associated with the second network node or the network interface while the state of the second network node or the network interface is the unavailable state.

2. The method of claim 1, wherein the received information indicates a change to the expected unavailability of the second network node or the network interface over time in accordance with a movement of a satellite associated with the first network node or the second network node.

3. The method of claim 1, wherein the information that indicates the expected unavailability of the second network node or the network interface is received from an information node periodically or in response to a request from the first network node.

4. The method of claim 1, further comprising:
transmitting, to the second network node, a message indicating the state of the second network node or the network interface between the first network node and the second network node.

5. The method of claim 1, further comprising:
prohibiting one or more procedures while the state of the second network node or the network interface between the first network node and the second network node is the unavailable state.

6. The method of claim 1, further comprising:
triggering one or more procedures related to managing the network interface between the first network node and the second network node while the state of the second network node or the network interface between the first network node and the second network node is the unavailable state.

7. The method of claim 1, wherein the received information indicates the state of the second network node or the network interface and a duration associated with the state, a location associated with the state, or a time of a next change to the state.

8. The method of claim 1, wherein the information that indicates the expected unavailability of the second network node or the network interface is associated with a trigger related to one or more of a movement of a satellite associated with the first network node or the second network node, a configured timing, a location associated with a satellite, or a periodic timer expiring.

9. The method of claim 1, further comprising:
transmitting, to the second network node, a message that includes a request to change the state of the second network node or the network interface between the first network node and the second network node, wherein the information that indicates the expected unavailability of the second network node or the network interface is responsive to the request.

10. The method of claim 1, further comprising:
transmitting, to the second network node, a request to change the state of the second network node or the network interface between the first network node and the second network node, wherein the request is transmitted in response to receiving the information that indicates the expected unavailability of the second network node or the network interface.

11. The method of claim 1, wherein the information that indicates the expected unavailability of the second network node or the network interface between the first network node and the second network node is associated with a setup message for the network interface or a configuration update message.

12. The method of claim 1, further comprising:
determining, in accordance with the received information, that the state of the network interface has changed from the unavailable state to an available state; and
communicating with the second network node over the network interface in accordance with the application layer configuration responsive to the state of the second network node or the network interface changing to the available state.

13. The method of claim 12, wherein communication with the second network node over the network interface is associated with a transport network layer (TNL) identifier associated with the second network node.

14. The method of claim 13, wherein the TNL identifier associated with the second network node is a TNL identifier that is assigned to the second network node in a configuration update.

15. The method of claim 12, wherein communication with the second network node over the network interface is associated with an identifier or a name associated with the second network node.

16. The method of claim 12, wherein communication with the second network node over the network interface is associated with a key parameter associated with the second network node.

17. The method of claim 1, further comprising:
detecting that the application layer configuration is not available in the second network node; and
triggering a setup procedure to establish the application layer configuration associated with the network interface responsive to detecting that the application layer configuration is not available in the second network node.

18. The method of claim 17, wherein detecting that the application layer configuration is not available in the second network node is in accordance with one or more of a failure count associated with a configuration update procedure, expiration of a time period from a start of the configuration update procedure, or an indication included in a failure message associated with the configuration update procedure.

19. An apparatus for wireless communication, comprising:
one or more memories; and
one or more processors coupled to the one or more memories, the one or more processors individually or collectively configured to:
receive information that indicates an expected unavailability of a network node or a network interface between the apparatus and the network node;
determine, in accordance with the received information, that a state of the network node or the network interface between the apparatus and the network node is an unavailable state; and
maintain an application layer configuration associated with the network node or the network interface while the state of the network node or the network interface is the unavailable state.

20. An apparatus for wireless communication, comprising:
means for receiving information that indicates an expected unavailability of a network node or a network interface between the apparatus and the network node;
means for determining, in accordance with the received information, that a state of the network node or the network interface between the apparatus and the network node is an unavailable state; and
means for maintaining an application layer configuration associated with the network node or the network interface while the state of the network node or the network interface is the unavailable state.
